(19) United States
(12) Patent Application Publication
(10) Pub. No.: US 2012/0084180 A1
(43) Pub. Date: Apr. 5, 2012

(54) Personal Growth System, Methods, and Products

(76) Inventors: Catherine D. Dowdell, Caledonia, WI (US); Michael M. Sawalski, Racine, WI (US); John R. Weaver, Waukesha, WI (US); Thomas A. Helf, New Berlin, WI (US); Marissa A.K. Schultz, Racine, WI (US); James R. Crapser, Racine, WI (US); Sara Cantor Aye, Chicago, IL (US); Mark King, Des Plaines, IL (US); Andrew Michael Brooks, Chicago, IL (US); Kristina J. Genslak, Racine, WI (US); Felicia E. Zusman, Highland Park, IL (US)

(21) Appl. No.: 12/896,775

(22) Filed: Oct. 1, 2010

(51) Int. Cl. G09B 19/00; G06Q 30/00

(52) U.S. Cl. 705/27.1; 434/236

(57) ABSTRACT

A personal growth system and method for personal growth are provided. The personal growth system may be web-enabled and may include a communication interface operable to communicate with an endpoint user interface. The user interface generally includes a display area. The personal growth program is operable to generate, for a user in the display area, a first information request for the user and to obtain first user input relating to the user's current state of being. The personal growth system also may include a recommendation database defining guided experiences, each of which may include at least one instruction that leads the user through the guided experience. The personal growth system may communicate applicable guided experiences to the endpoint based on the first user input. The instructions of the guided experiences may specify an act intended to generate a result. The personal growth program may be further operable to generate, for the user in the display area, a second information request and to obtain second user input relating to the result. An account database in the personal growth system stores a growth interaction history of the user, which may include the first user input, the selected guided experience, and the second user input relating to the result of the selected guided experience.

### FIELD OF THE INVENTION

The present application is directed to a personal growth system and related methods and products, and more particularly to a web-enabled personal growth system and method of promoting personal growth.

### BACKGROUND

The demands of contemporary living require constant attention throughout the day. Daily life activities include work, family, socializing and more. The constant juggling of other people's needs in addition to one's own needs leaves little time for one's self. These activities may become detrimental to one's personal growth, for example when the to-do lists become too long, the challenges seem insurmountable, concentration or focus is lost due to competing needs, personal fulfillment is lacking or similar issues.

There is a need to make daily life activities more meaningful and to promote personal growth to facilitate wellness and balance in life. Daily activities or any life activities can become more meaningful when a person is connected to awareness. A system to help direct one's thoughts toward awareness may facilitate personal growth.

Many people may be unsure about which of the numerous exercises, products, or systems intended to promote personal growth or reduce stress levels are best suited to their particular needs, or they may be reluctant to dedicate a substantial amount of time to activities, products, or systems that promise to promote personal growth, reduce stress, or achieve some other desired result. Moreover, one exercise or product may be effective on one occasion, but not another occasion, leading people to be frustrated with their choices and progress in personal growth and abandon the practice altogether. Additionally, because feelings and needs may vary, one may not want to be tied down to a particular exercise, product, or system that is suited for a particular feeling, such as stress. One may also be reluctant to transport books or products of a personal growth system to the workplace. Online meditations may be convenient, but may lack any features that tailor the experience to a particular user.

A need exists to address the problems noted above and others previously experienced.

### SUMMARY

In one implementation, a web-enabled personal growth system is provided. This web-enabled personal growth system includes a communication interface operable to communicate with an endpoint, and in particular to a user interface including a display area, for displaying at least one visual element. The system includes a personal growth program, operable to generate for the user in the display area a first request for information from the user and obtains first user input relating to the user's current state of being. This information relating to the user's current state of being may include information as to the user's mood, thoughts, or feelings or a desired “intention”, where an “intention” is a desired goal or attribute, of the user. The system includes a recommendation database, which includes guided experiences. Each guided experience may include at least one instruction that leads the user through that guided experience. The instruction may specify an act intended to generate a result. A guided experience may also be labeled, referred to, or described as a “moment” below and in the figures. Regardless of which term is used, one associated goal is to provide one or more instructions that direct the user to perform acts in furtherance of a result desired for the user. The personal growth program may further be operable to generate for the user in the display area, a second information request and to obtain second user input relating to the result. The personal growth system may also include an account database for storing growth interaction history for the user, which may include first user input relating to the user's state of being, the selected guided experience, and the second user input relating to the result of the selected guided experience.

The personal growth program of the personal growth system may generate instructions including, as examples, textual prompts, pictorial prompts, or audio prompts. Any of the instructions for the guided experience may, as examples, encourage the user to be aware of oneself, the present moment, or the user's surroundings.

Further, the personal growth program may select a guided experience based on the first user input relating to the user's state of being. Alternatively, the personal growth program determines the guided experience using the growth interaction history. In another example, the guided experience is selected by the user from a list of guided experiences generated by the personal growth program.

The guided experience may include the use of a product. The product may be an oil, a lotion, a body cleansing product, a bath product, a linen spray, a lip balm, a candle, a package of tea, a note that is dissolvable in water, a set of cards, or a journal, as examples. In one embodiment, the product corresponds to an intention specified in the first user input. The personal growth system may also include a product purchase program operable to process a purchase request for any combination of products and services offered to the user in connection with the selected guided experience.

The personal growth system may recommend that the user perform an act. Examples of recommended acts may include taking deep breaths, closing eyes, meditating, smelling a scent, viewing an image, performing body movements, listening to music, writing thoughts or feelings on a fixed medium, typing thoughts or feelings on a keyboard, or speaking thoughts or feelings aloud, for example.

The personal growth system may further be operable to generate and display in the display area a prompt that encourages a user to create a journal entry, or a prompt that notifies the user of an option to download the guided experience to a mobile device.

In another implementation of the system, a method of promoting personal growth is provided. This method includes storing in a memory first user input obtained with a personal growth program that prompts a user for first user input specifying a current state of being for the user. The method further includes obtaining, from a recommendation database, a guided experience for the user based on the first user input, where the guided experience includes an instruction for performing an act intended to generate a result for the user. The method may further include communicating the instruction, through a communication interface, to an endpoint associated with the user and communicating, through the communication interface to the endpoint, a request to the user to reflect on the result and the performance of the act. The method may further include using the personal growth program to obtain second user input including a rating of the guided experience and information relating to whether the result was obtained for the user, and storing the second user input in an interaction history for the user in an account database.

The first user input may specify a desired intention. The desired intention may be selected by the user from a predetermined set of intentions generated by the personal growth program, which may include grounded, creative energy, gratitude, loving kindness, courage, wisdom, and inspiration, for example. The first user input may specify any one or more of the user's mood, thoughts, or feelings.

The act specified in the guided experience in the recommendation database may include taking deep breaths, closing eyes, meditating, smelling a scent, viewing an image, performing body movements, listening to music, writing thoughts or feelings on a fixed medium, typing thoughts or feelings on a keyboard, or speaking thoughts or feelings aloud, as examples.

The method may further include communicating, through the communication interface to the endpoint, a recommendation to write in a physical or electronic journal, as examples.

The method may further include communicating, through the communication interface to the endpoint, a recommendation for the user to engage in a guided experience multiple times by incorporating the guided experience into the person's schedule and communicating, through the communication interface to the endpoint, a recommendation for the user to share with others any combination of thoughts, feelings, or emotions relating to the guided experience

The method may further include communicating, through the communication interface to the endpoint, a recommendation for a product, service, or both for the user to purchase in support of the guided experience. The method may further include accepting a purchase request from the user for the product, service, or both and processing the purchase request for the user.

### BRIEF DESCRIPTION OF THE DRAWINGS

FIG. 1 is an illustrative diagram of one embodiment of a web-enabled personal growth system;

FIG. 2 is a illustrative screen shot of the home page of one embodiment of a personal growth system;

FIG. 3 is a illustrative screen shot of an information request relating to the user's current mood, thoughts, or feelings;

FIG. 4 is a illustrative screen shot of an option for the user to choose a feeling;

FIG. 5 is an illustrative screen shot of a guided experience;

FIG. 6 is a illustrative screen shot of a guided experience menu page;

FIGS. 7A-7E are illustrative screen shots of an “Om Mantra” guided experience;

FIGS. 8A-8E are illustrative screen shots of a “Joy Breath” guided experience;

FIGS. 9A-9E are illustrative screen shots of an “Easy on the Eyes” guided experience;

FIGS. 10A-10E are illustrative screen shots of a “Side Stretch” guided experience;

FIG. 11 illustrates the intentions, and the associated symbols and scents of the journal system of one embodiment;

FIGS. 12A-12G are illustrative screen shots of a “Paying Attention” guided experience;

FIGS. 13A-13H are illustrative screen shots of a “Worry to Action” guided experience;

FIG. 14 is a illustrative screen shot of a scheduling program;

FIGS. 15A-15C are illustrative screen shots of Life aspects: Forum, News, and Reach Out;

FIG. 16 is a illustrative screen shot of an online boutique;

FIG. 17 is an illustrative diagram of a personal growth system and method;

FIGS. 18A-18B are plan views of a card of a journal system;

FIG. 19 shows an example of the logic that a personal growth program may implement in a personal growth system; and

FIG. 20 shows an example of the logic that a product purchase program may implement in a personal growth system.

The same reference numbers may be used throughout the drawings to refer to the same or like parts.

### DETAILED DESCRIPTION

The relationship and functioning of the various elements of the system are better understood with reference to the following detailed description and associated drawings. However, system is not limited to the embodiments illustrated in the drawings. It should be understood that the drawings are not necessarily to scale, and in certain instances details have been omitted which are not necessary for an understanding of the present systems and method, such as conventional fabrication and assembly.

In one implementation, a web-enabled personal growth system is provided. The personal growth system may be used, for example, to relieve stress, restore focus, achieve balance, clear the mind, or otherwise improve one's mood, thoughts, or feelings. Using some embodiments of the personal growth system, a user can achieve his or her targeted outcome in a minimal amount of time, such as less than a minute, less than five minutes, or less than ten minutes.

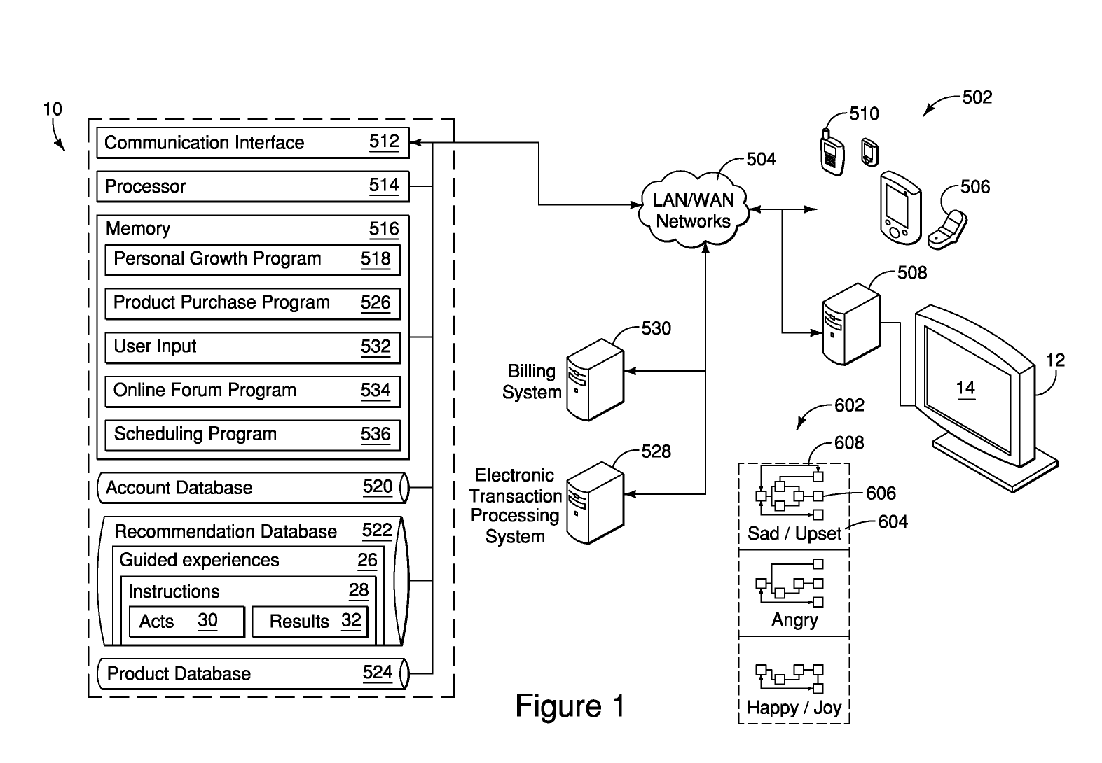

FIG. 1 shows a personal growth system 10 (“system 10”). The system 10 connects to endpoints 502 over the networks 504. As will be explained in more detail below, the system 10 provides guided experiences tailored to individual users' states of being, including feelings, emotions, moods, desired intentions, or other characteristics. The endpoints 502 may be any of a wide range of devices. As examples, the endpoints 502 may be mobile phones 506, computers 508, personal data assistants (PDAs) 510 or other devices.

The networks 504 may adhere to a wide variety of network topologies and technologies. For example, the networks 504 may include Ethernet and Fiber Distributed Data Interconnect (FDDI) packet switched networks communicating Transmission Control Protocol/Internet Protocol (TCP/IP) packets, or any other communication protocol data. Thus, the networks 504 represent a transport mechanism or interconnection of multiple transport mechanisms for data exchange between the system 10 and the endpoints 502.

In the system 10, the communication interface 512 connects to the networks 504 to facilitate data exchange between the system 10 and the endpoints. The processor 514 communicates with the memory 516, for example to execute the personal growth program 518. As described in more detail below, the personal growth program 518 may, among other features, interact with a user at an endpoint to determine mood/intention and deliver guided experience selections, product selections, and other information to the user.

In one implementation, the system 10 represents a server that hosts the personal growth program 518. As detailed in the screenshots below, the system 10 and personal growth program 518 may implement a web-based interface for the users. In that regard, any number of Internet connected users may access the system 10 through the networks 504 to interact with the system 10 as noted below. In other implementations, the personal growth program 518, databases, and other functionality of the system 10 may be directly hosted on a local endpoint (e.g., as software installed on a home computer or smart phone). In such implementations, the local endpoint need not have network connectivity, although it may in order to facilitate orders for products or services that are recommended by the personal growth program 518, as one example.

An account database 520 stores user account information, such as name, age, address, and other information. In addition, the account database 520 may store growth interaction history with the system 10. The growth interaction history may include the history of the guided experiences delivered to the user by the personal growth program 518, the user inputs regarding moods, thoughts, feelings, intentions or other user aspects.

The recommendation database 522 may store predefined guided experiences 26 that the personal growth program 518 may recommend. The guided experiences 26 may be composed of instructions 28 (e.g., in verbal, written, musical, video, or other form) that direct the user to perform acts 30 in furtherance of the guided experience recommended to the user. The acts 30 may be tagged or otherwise associated with desired results 32. For example, the act of meditating for five minutes may be tagged with the desired results of 1) reduce stress, and 2) become calm. Furthermore, the system 10 may also store characteristic attribute/value data for the guided experiences. The attribute/value data may, as explained in more detail below, facilitate determining and recommending products and services to the user in furtherance of pursuing the guided experiences.

One goal of presenting the guided experiences to the users is to try to generate the desired results 32 in the users. Thus, when the personal growth program 518 recommends guided experiences, the personal growth program 518 may make such recommendations based on the desired results 32 that are associated with any particular guided experience in the recommendation database 522. Furthermore, the personal growth program 518 may communicate the desired results 32 to the endpoints 502 to help users make their own guided experience selections.

The product database 524 may store product and service information for products (e.g., candles, incense, and soap) and services (e.g., massages or pedicures). The personal growth program 518 may, in the course of the guided experience, select and display products and services to the user that are appropriate for the guided experience. In that regard, the system 10 may further include a product purchase program 526 that interacts with an electronic transaction processing system 528 (“ETPS 528”) and billing system 530 to display available products and services, obtain a user selection of products and services to purchase, and obtain payment information (e.g., credit card number information). The product purchase program 526 may then submit the product and billing information to the ETPS 528 and/or the billing system 530 to carry out the attempted transaction for the products and services.

As one example, the ETPS 528 may be an electronic commerce server, such as a Microsoft (TM) Commerce Server (TM) system. Such a system may expose a defined Application Programming Interface (API) toward the system 10. The product purchase program 526 may interact with the API, as examples, to query for available products and services that match any search criteria, including criteria that characterize any of the guided experiences, instructions, acts, intentions, or other aspects of the system implementation. Thus, for example, when the user is moving through a given guided experience, the product purchase program 526 may query the ETPS 528 with attribute/value data pre-defined and associated with the guided experience (or instruction, act, or intention) to obtain the products and services that are appropriate (and are as defined in the ETPS 528 database with matching data) for the attribute/value data. The product purchase program 526 may then display the product and service results obtained from the ETPS 528 for selection and purchase by the user. Suggested products and services may be determined in many other ways, however. Alternatively or additionally, the system 10 may chose products at random, may recommend pre-selected products for a given guided experience, may suggest products based on current discount or incentive data supplied by product manufacturers, or in other ways.

The product purchase program 526 may perform a handoff of the user to the ETPS 528 for purchasing products and services. In that regard, the ETPS 528 may include a user interface skinned in the same manner as the user interface generated by the system 10 in order to make the handoff unnoticeable, or even seamless. Regarding the handoff, the product purchase program 526 may pass user credentials (e.g., username or other identifiers) to the ETPS 528. In turn, the ETPS 528 may then continue to process the product selection, checkout, payment, billing, and shipment functions for the purchased products and services, knowing the specific user involved.

As will be described in more detail below, the system 10 recommends guided experiences appropriate for users' feelings, moods, or other characteristics. In one implementation, the system 10 generates and delivers a web interface of visual elements, functional logic, or other interface components to an endpoint (e.g., in the form of Hypertext Markup Language (HTML) web pages, active server pages, Java script, or other web interface components). The endpoints 502 may render the web interface in the display area 14 of a user interface 12. The user interface 12 may be a device display, such as a home computer monitor or the LCD screen of a smartphone, as examples. The display area 14 may be one or more windows of a web browser or other application.

The system 10 accepts and stores in the memory 516 user purchase input 532 from the endpoints 502 responsive to keyboard keystrokes, mouse movement or mouse clicks, or other input. The user purchase input 532 may, as examples, drive the behavior of the personal growth program 518 (e.g., by specifying user mood and a selection of a guided experience) or product purchase program 526 (e.g., by specifying the products and services that the user desires to purchase, along with billing information). The personal growth program 518 and product purchase program 526 generate output to the user at their endpoint 502, including through the display area 14, speakers, printers, or other interface devices connected to their endpoint 502. The output generated by the system 10 may include displays of guided experience options that the user may choose from, selection interfaces for product purchases, the instructions for performing acts and their intended results, or other information. The output generated by the system 10 may also include information requests to obtain information regarding user account identifiers (e.g., an account login and password), user mood or intention, the perceived result of user actions recommended by the system 10 or selected by the user, or other information.

FIG. 1 also shows that the system 10 may include an online forum program 534. The online forum program 534 implements, as examples, online discussion groups, bulletin boards, instant messaging interfaces, or other social networking solutions. Users may then post to the social networking solutions to collaborate, discuss, analyze, or otherwise communication with each other regarding their states of being, guided experiences, or other characteristics.

Furthermore, a scheduling program 536 may be provided. The scheduling program 536 may facilitate scheduling future guided experiences. For example, the user may specify to the scheduling program 536 that the system 10 should provide a new guided experience once each day to the user. The scheduling program 536 may then request the personal growth program 518 to determine a guided experience, and then deliver the guided experience to the user through the communication interface 512 (e.g., by pushing or otherwise downloading the guided experience to the user's endpoint in an automated fashion).

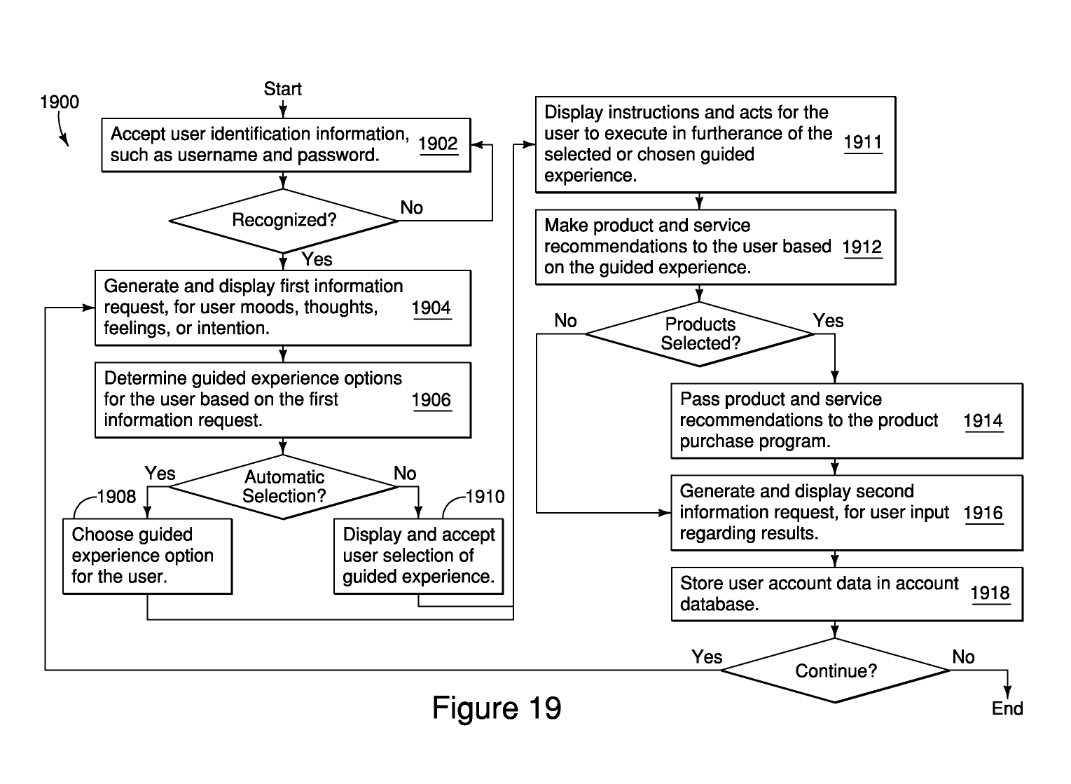

Turning briefly to FIG. 19, that figure shows an example of the logic 1900 that the personal growth program 518 may implement in the personal growth system 10. The logic 1900 accepts user identification information (1902), such as username and password information for logging into the system 10. Based on the user identification information, the logic 10 may determine which user is connected and may retrieve, save, and process growth interaction history and other information in the account database 520.

If the user is recognized, then the logic 1900 generates a first information request (1904): a “before experience” information request. The first information request may request user mood, thoughts, feelings, desired results, or intentions, or other user information prior to the user moving through a guided experience. Based on the user input obtained from the first information request, and from the account database 520 (e.g., the growth interaction history of the user), the logic 1900 may consult the recommendation database 522 and determine applicable guided experiences 26 for the user (1906). In some implementations, the logic 1900 may automatically select a guided experience (1908). As examples, the logic 1900 may choose, from the recommendation database 522, one or more guided experiences 26 that most closely match the types of results desired by the user, may choose the first such guided experience found in the recommendation database 522, may choose a guided experience 26 at random, may choose a guided experience 26 that would be new for the user based on interaction history, or may choose a guided experience in other ways. In other implementations, the logic 1900 may display the available guided experiences 26, and obtain an input selection from the user of the desired guided experience (1910).

Given the guided experience, the logic 1900 may then display the instructions and acts for the user to execute (1911). The instructions and acts help the user achieve the desired results associated with the guided experience that the logic 1900 chose or that the user chose. Furthermore, the logic 1900 may make product and service recommendations to the user (1912). The products and services are typically selected based on the selected guided experience and may include particular types of oils, candles, cleansing products, massage therapies, or other products and services that facilitate reaching the results desired for the guided experience. For example, as explained above, the logic 1900 may request the ETPS 528 to return available products and services appropriate to the guided experience based on matching attribute/value data associated with the guided experience. Alternatively or additionally, the logic 1900 may accept from the user a request may request or specify for particular products or services of interest to purchase, then submit that data to the ETPS 528. As another example, the logic 1900 may pass the user to the ETPS 528 for interacting with an eCommerce solution implemented on the ETPS 528 which handles product display and selection, checkout, payment, billing, and shipping functions.

When the user has selected products and services to purchase, the logic 1900 may pass the selection of product and services to the product purchase program 526 (1914). In turn, the product purchase program 526 may handle the purchase transaction as described below. Regardless, the logic 1900 may generate and display a second information request (1916). The second information request may obtain information from the user regarding the results of the guided experience. The logic 1900 stores the user input in the account database 520 for future analysis, along with other aspects of the growth interaction history with the user, such as the thoughts, feeling, emotions, and intentions over time, the recommended or user selected guided experiences, products and services purchased, and other interaction history.

The user may continue to interact with the personal growth program 518 for as long as desired. Accordingly, if the user selects to continue, the personal growth program 518 may return to generate another instance of the first information request to ask how the user now feels (1904) after moving through the guided experience. On each iteration, after the first, the personal growth program 518 may determine an appropriate guided experience (1906) based on the past input given responsive to the second information request, as well as based on the current state of being specified in response to the first information request.

In that regard, the personal growth program 518 may link together any desired sequence of guided experiences. The personal growth program 518 may define transitions between guided experiences based on the answers obtained from the first information request and second information request, or other criteria. Thus, transitions between guided experiences may by implemented in the system 10 in the same or similar manner as state machines, with the guided experiences representing the next state (and the next guided experience) chosen by the personal growth program 518, and the transitions between states driven by answers to the first and second information requests.

In one implementation, the logic 1900 generates a first information request to obtain information concerning the user's state of being (e.g., the user's moods, thoughts, feelings or intention) (1904) and responsively obtains the first input. Based on this first input, the personal growth program 518 may automatically choose or recommend a guided experience 26 for the user (1908).

For example, the logic 1900 may implement guided experience groups 602 (FIG. 1) defined in the memory 516 or recommendation database 522. Each guided experience group (e.g., the group 604) may be established to encompass any number of states of being selections (e.g., the selection for “Sad/Upset”) for which a particular guided experience group applies. The guided experience group defines individual guided experiences (e.g., the guided experience 606), and transitions between guided experiences (e.g., the transition 608), e.g., in a state machine form. Any guided experience group may define a starting guided experience for the user (e.g., the guided experience first chosen for the user when the logic 1900 learns the answer to the first inquiry concerning state of being). Any of the guided experiences in a guided experience group may be designated as the starting guided experience.

After the user has engaged in the specific guided experience, the logic may then generate and display a second information request for user input regarding the results of engaging in the guided experience (1916). This second information request may ask the user how he or she is feeling at the conclusion of the guided experience (e.g., at the conclusion of the starting guided experience). The logic 1900 stores this input as to how the user felt after concluding the guided experience in the account database 520. Based on the user input regarding the result of engaging in the specific guided experience, the logic (1900) may recommend a specific second guided experience to the user.

For example, the logic 1900 may examine the transitions 608 defined between guided experiences in the applicable guided experience group. Each transition 608 may specify the criteria on which the transition is made. The criteria may include the answers the user provides to the second information request, the answers provided to the first information request, other information, or any combination of information. The personal growth program 518 may move between guided experiences in either direction along the transitions, if the transitions permit.

In this manner, the logic 1900 may move the user between any or all of the specific guided experiences defined in a guided experience group, as influenced by the prior guided experiences as well as the user input regarding the results of prior guided experiences.

By way of specific example, if the user input is that he or she is feeling sad, the system may choose a specific guided experience A for the user designed to address the specific feeling of sadness. After the user engages in the guided experience, the logic 1900 may ask the user how he or she is feeling at the conclusion of the guided experience. The user may respond that he or she is feeling calm. Because the user was initially feeling sad, engaged in a guided experience A, and at the conclusion of the guided experience felt calm, the personal growth program may evaluate the transition criteria and recommend guided experience B for the next guided experience for the user.

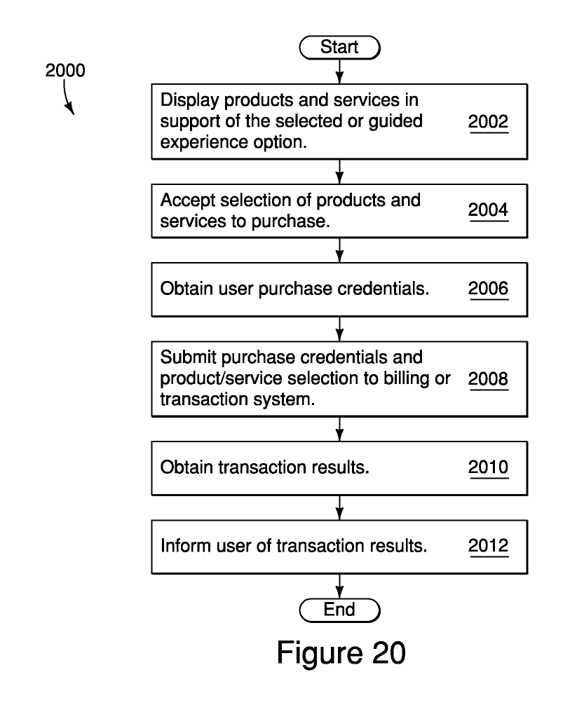

FIG. 20 shows an example of the logic 2000 that a product purchase program 526 may implement in a personal growth system 10. The product purchase program 526 may be part of the personal growth program 518, may be a separate application, or may be implemented in other ways. In particular, the logic 2000 may display products and services in support of a given guided experience for a user (2002). As noted above, in one implementation, the logic 2000 may query the ETPS 528 for appropriate products and services based on characteristic data defined for any selected guided experience. The logic 2000 may then accept, as a purchase request, selections of products and services for purchase based on direct interaction with the user, or based upon product and service selection information received from the logic 1900 (2004), or obtained in other ways (e.g., specified by the personal growth program 518 as a recommended or mandatory purchase for a particular guided experience). Given a selection of products and services, the logic 2000 may obtain user purchase credentials for the transaction (2006). Such credentials may include credit card, debit card, gift card, checking account or other account numbers, as well as authorization codes, promotional codes, discount codes, or other information. The logic 2000 submits the purchase credentials and product/service selection to business support systems, such as the transaction processing system 528 (e.g., for handling credit card verification) or billing system 530 (for generating invoices for the user) (2008). The logic 2000 obtains the transaction results from the business support systems (2010), including whether the transaction is approved or denied. The logic 2000 then informs the user of the transaction result (2012).

In other implementations, any of the product selection, checkout, payment, billing, and shipping functions may be handled in whole or in part by the ETPS 528. For example, as described above, the personal growth program 518 or product purchase program 526 may handoff the user to the ETPS 528. The ETPS 528 may then interact with the user to complete product and service purchases.

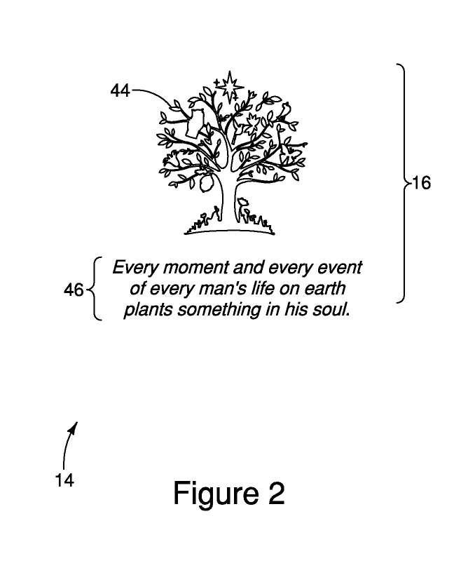

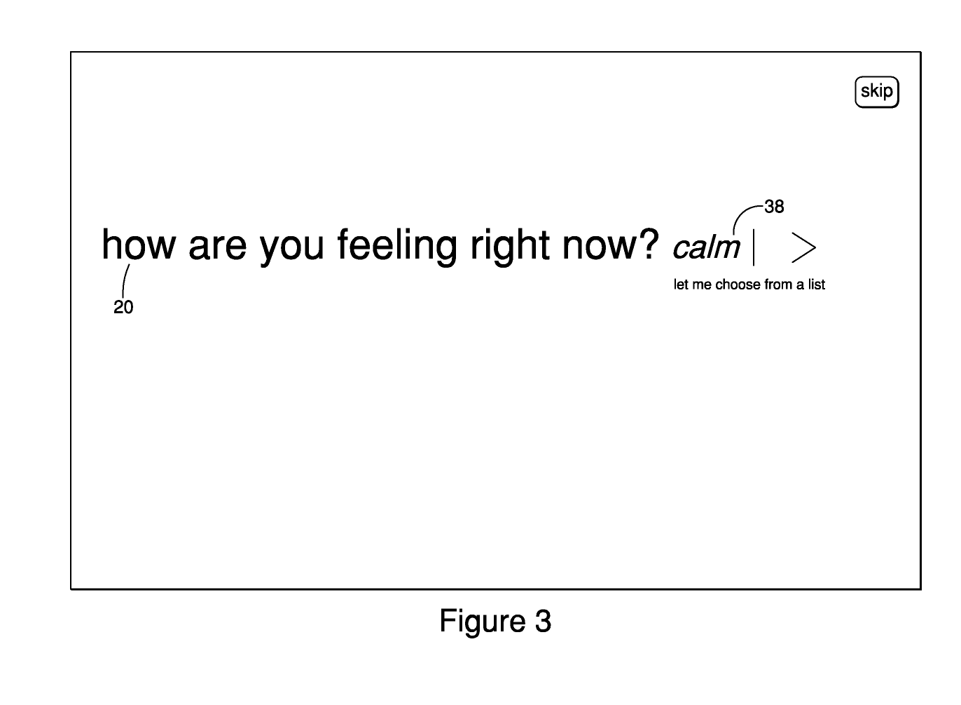

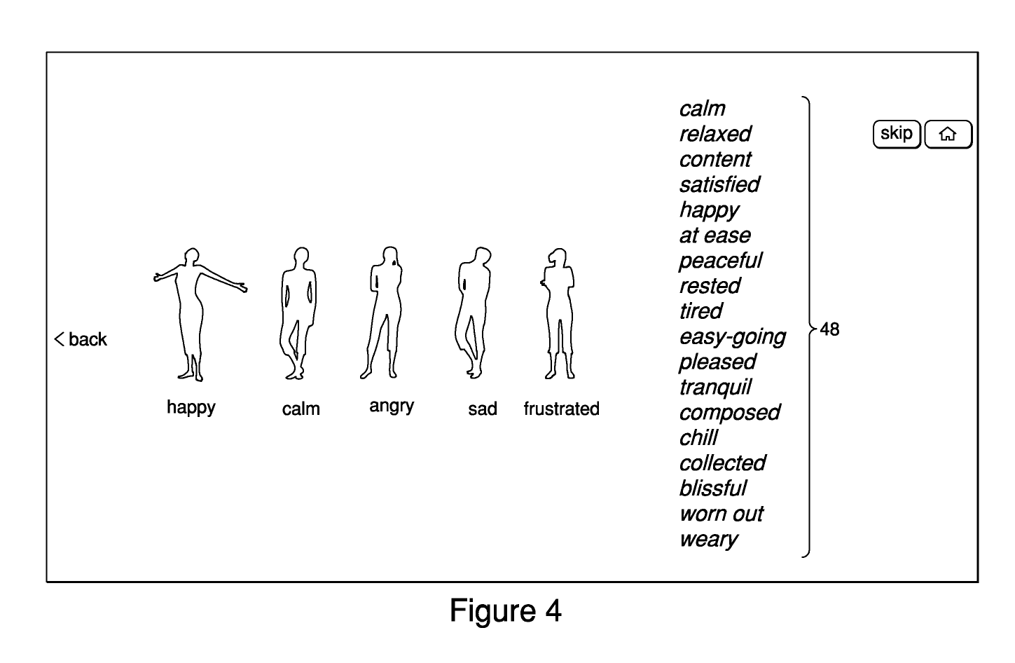

Returning now to FIG. 2, which is a screen shot of the home page of one embodiment of the personal growth system 10, the personal growth system 10, through the personal growth program 518, generates a display area 14 on a user interface 12 in the form of a webpage. The webpage initially displays a visual element 16. In the embodiment as shown in FIG. 2, this visual element 16 is a tree design 44 and text 46. After the visual element 16 appears, the personal growth program 518, generates a first information request 20, a “before experience” information request, to the user. The first information request 20 asks for information relating to the user's mood, thoughts, or feelings prior to the user moving through a guided experience. The first information request 20, as shown in FIG. 3, may include the question “How are you feeling right now?” The user may respond by providing his or her first user input 38. In FIG. 3, the first user input 38 is shown to be the word “calm.” In one embodiment, the user may provide this first user input 38 by typing in an answer or by choosing a response from a list of feelings 48: a “before experience” state of being list, such as “happy”, “calm”, “angry”, “sad”, or “frustrated”, as shown in FIG. 4.

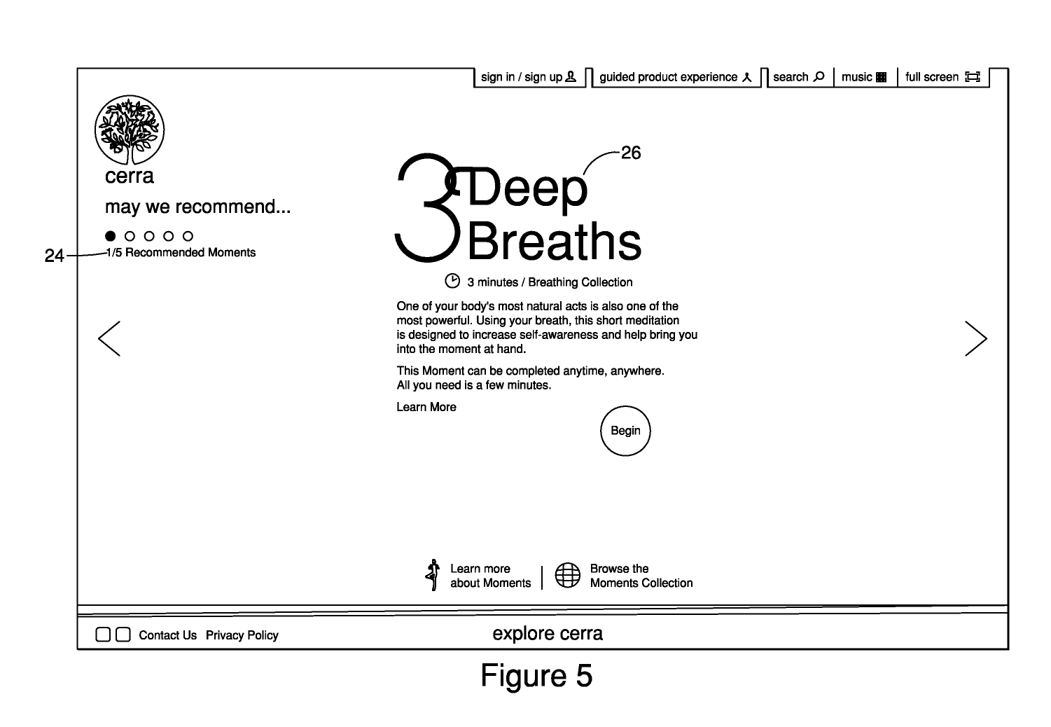

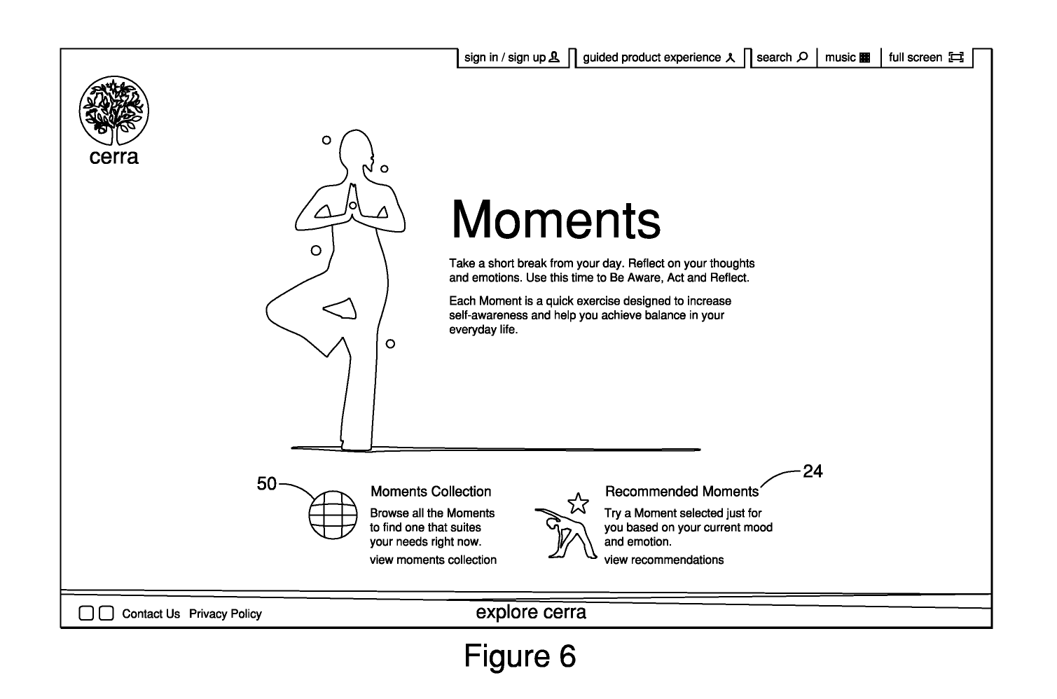

In some embodiments of the personal growth system 10, the personal growth program 518 may further encourage the user to engage in a “guided experience” 26. The personal growth program 518 may lead the user through the guided experience 26 by a series of instructions 28, textual prompts, pictorial prompts, or other output, presented to the user at their endpoint or delivered in print or other media, such as by a CD-ROM or other digital file, for example. The guided experience 26 may be selected by the user or chosen automatically by the personal growth program 518. In one embodiment, the first user input 38 to the first information request 20 relating to the user's current mood, thoughts, or feelings determines which guided experience options 24 that the personal growth program 518 presents to the user. For example, in FIG. 5, the guided experience option that the personal growth program 518 delivers to the user is a “3 Deep Breaths” guided experience 26, although many others may be defined in the recommendation database 522 and delivered to the user by the personal growth program 518. In another embodiment, the user may select one of the recommended guided experience options. FIG. 6 shows one example of a guided experience menu page that the personal growth program 518 may generate to facilitate user selection of a guided experience from recommended guided experience options 24, labeled as “Recommended Moments” in FIG. 6. Alternatively, the user may choose to review a complete listing of all the available guided experiences 26 or a listing of a certain category of guided experiences, the “Moments Collection” 50 as shown in FIG. 6, and select one from the listing, or choose from the listing an experience in which he or she has engaged in previously and would like to repeat. In certain instances, the user may wish to choose from a listing of recommended guided experiences, but the system may not recognize the user's input relating to his or her current mood, thoughts, or feelings sufficiently to recommend specific experiences. In that situation, the system may simply recommend a random selection of experiences from which the user can choose.

In another embodiment, the guided experience options 24 are informed by the user's growth interaction history, which may include input relating to the user's current mood, thoughts, or feelings; input relating to the user's current mood, thoughts or feelings prior to a previous guided experience; input relating to the result of a previous guided experience; or a record of the guided experience. One way in which this may be accomplished is to obtain and track user input or feedback on the result.

The content of the guided experience 26 may vary considerably. The guided experiences 26 generally involve instructing the user to “be aware”, “act” and/or “reflect.” By way of non-limiting example, the “be aware” prompt may instruct the user to think about an experience of an event; the “act” prompt may instruct the user to perform a physical act 30 relating to the event or thought that the user has become aware of based on the “be aware” prompt; and the “reflect” prompt may direct the user to reflect on the result 32 or feelings the act brought about. The result may be a transformation of an undesired mood into a desired mood, a reduction in stress, an improvement in the balance of the user's life, or other desired result.

In some embodiments, the guided experience 26 involves acts 30 that facilitate the user's awareness of oneself or one's surroundings. In certain embodiments, the guided experience 26 involves deep breathing, closing one's eyes, visualization, meditation, smelling a scent, viewing an image, performing body movements, listening to music, writing thoughts or feelings on a fixed medium, typing thoughts or feelings on a keyboard, or speaking thoughts or feelings aloud.

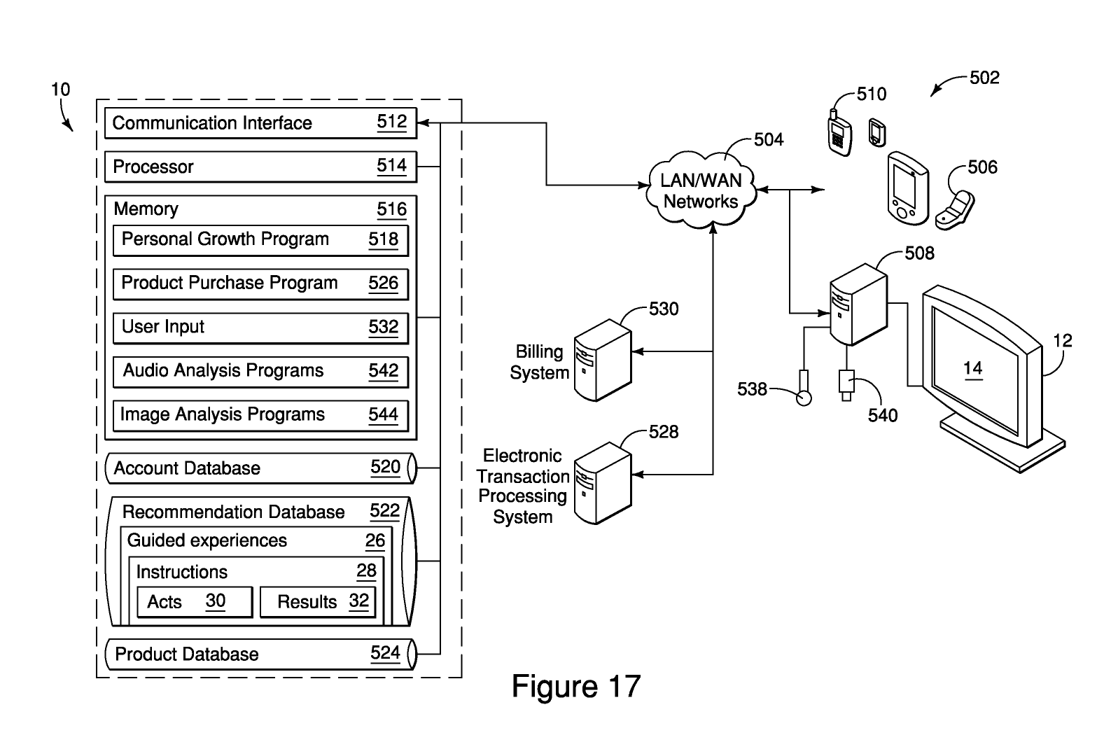

The personal growth system 10 provides for user interaction with the personal growth program 518, which may then generate output based on information or data collected relating to the user's performance of an instruction 28, act 30, or other aspect of a guided experience 26. This interaction may be facilitated by devices in communication with an endpoint 502, as shown in FIG. 17. As an example, any endpoint 502, such as the computer 508, may include a microphone input that receives signals from an attached microphone 538. During a guided experience that guides the user through breathing or chanting actions, as examples, the microphone 538 may capture an audio signal representative of the user's breath or vocalizations. The audio signals sensed by the microphone 538 are digitized by the computer 508 and may be returned to the system 10 for analysis, such as by the audio analysis programs 542. The audio analysis programs 542 may analyze the time or frequency content of the signals obtained from the endpoint to determine, as examples, how hard the user is breathing or whether the user is vocalizing the correct syllables.

The system may return feedback to the user, which facilitates the user to monitor their performance of a recommended instruction or act. The feedback may take many forms. As one example, the personal growth program 518 may generate visual images in response to the information regarding the intensity or rate of breath or vocalizations as communicated by the computer 508 through the microphone. As one specific example, the movement of visual images of leaves on the display area may correspond to the rate and intensity of the breathing or vocalization. Thus, the system 10 may, if desired, provide an interactive experience for any guided experience 26, rather than delivering simple instructions to the user to perform certain acts.

In another example, any endpoint 502 may include a video interface for an attached camera 540. The endpoint 502 may then capture images from the camera 540 and return them to the system 10 for analysis. To that end, the personal growth system 10 may include pattern recognition software, for example, facial recognition software or other image analysis programs 544. In this example, the personal growth program 518 may generate visual images, audio, or other feedback in response to the image information obtained from the camera 540, e.g., facial movements identified by the facial recognition software. In yet another example, an endpoint such as the mobile phone 506 may include accelerometers, gyroscopes, or other motion sensor devices that sense the user's movements. The endpoint may then communicate the sensor data to the personal growth program 518 for analysis. In turn the personal growth program 518 may generate interactive feedback to the user in the form of images, audio, or other feedback in response to the rate, nature, pattern, extent, or other characteristic of the movements.

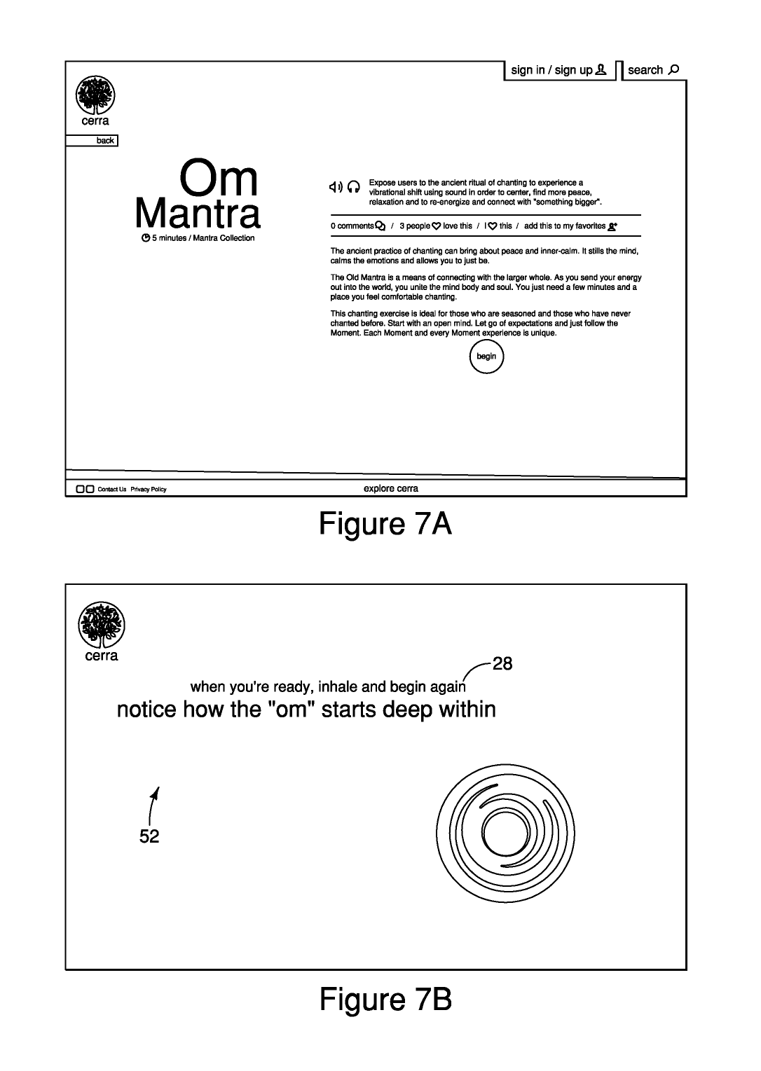

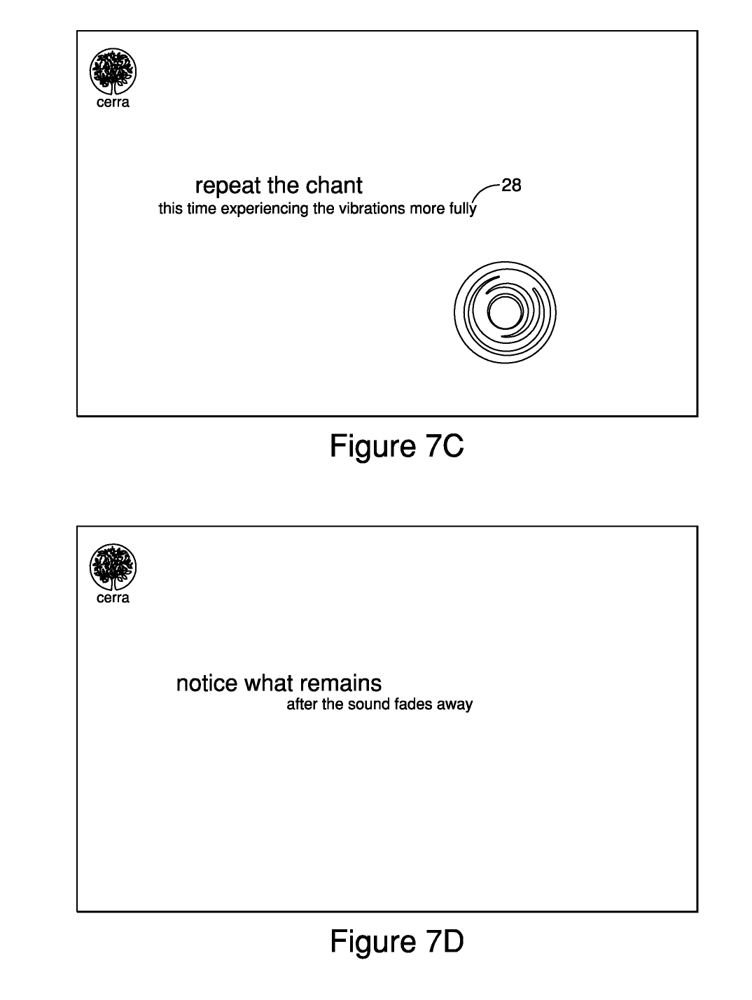

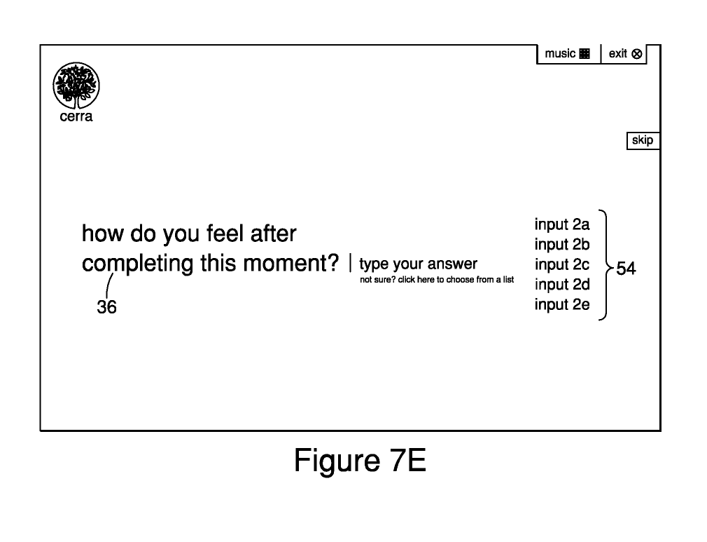

In one guided experience 26 shown in FIGS. 7A-7E, the “Om Mantra”, the user is encouraged to engage in the practice of chanting. As shown in FIG. 7A, textual and audio prompts encourage the user engage in a physical act 30, here breathing and chanting 52 the Om mantra. A series of instructions 28 guide the user through the breathing and chanting 52, an example of which are shown in FIGS. 7B and 7C, and then the user is provided some moments of silence to reflect on the result 32, as shown in FIG. 7D. In addition, the personal growth program 518 may generate a second information request 36: an “after experience” information request. The second information request 36 requests a second user input relating to the result and feelings experienced by the user after completing the guided experience or moment. An example of the second information request 36 is shown in FIG. 7E: “How do you feel after completing this moment?”. If the user is unable or unwilling to generate his or her own second user input 40, he or she may choose from a predefined list 54: an “after experience” state of being list of inputs.

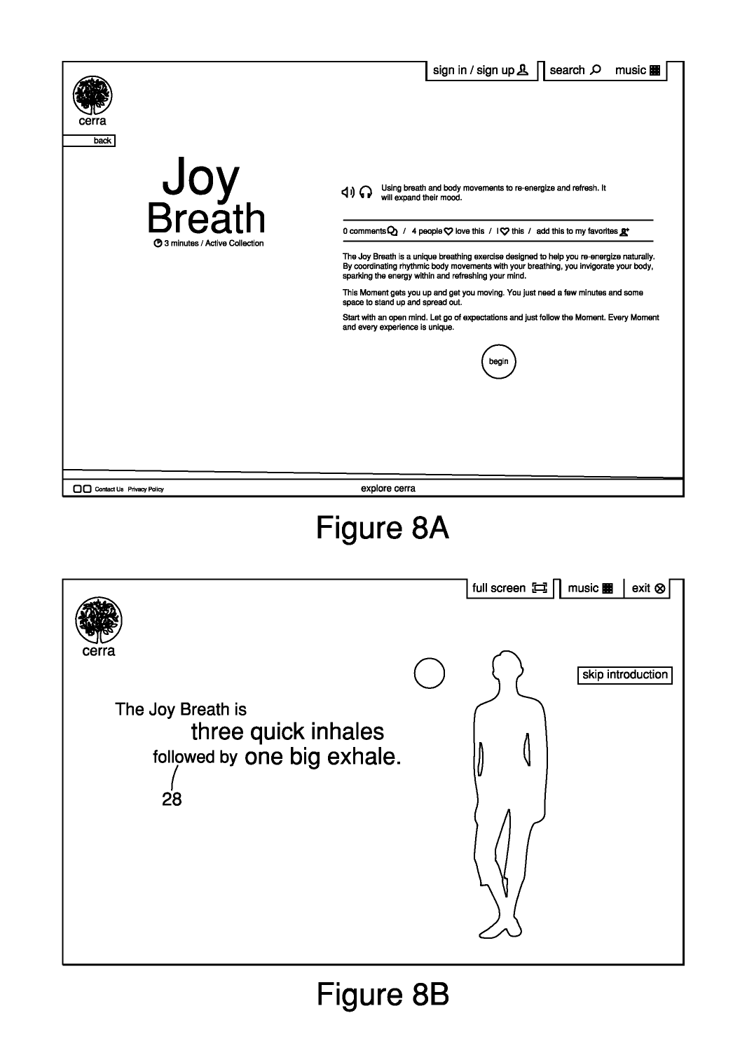

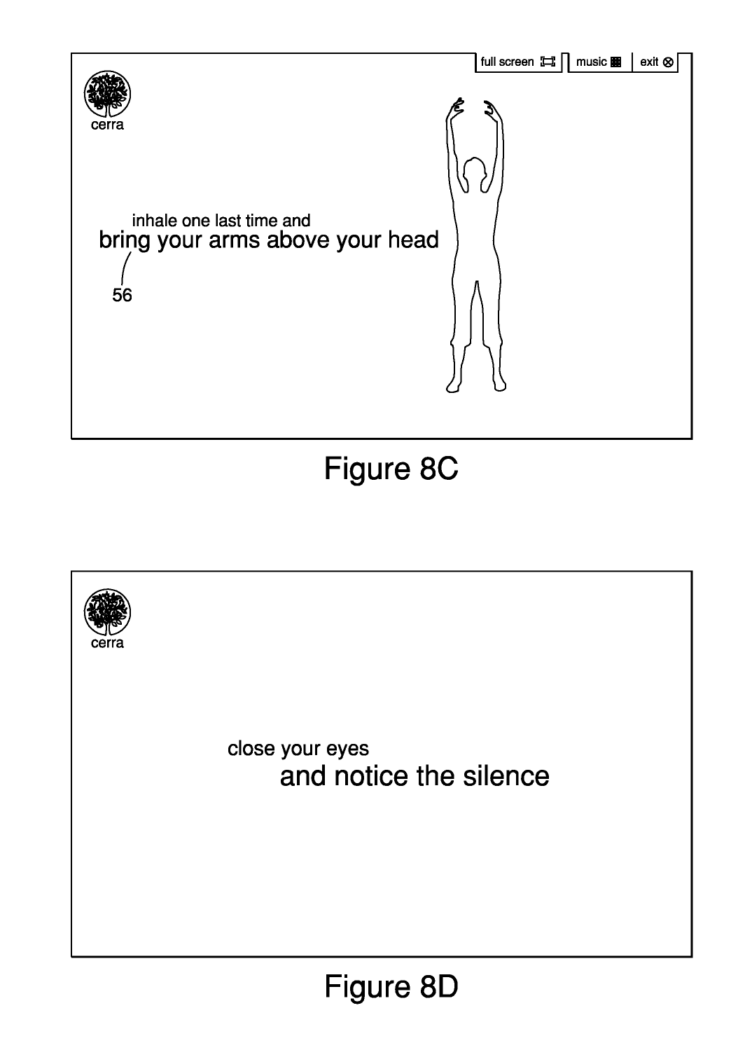

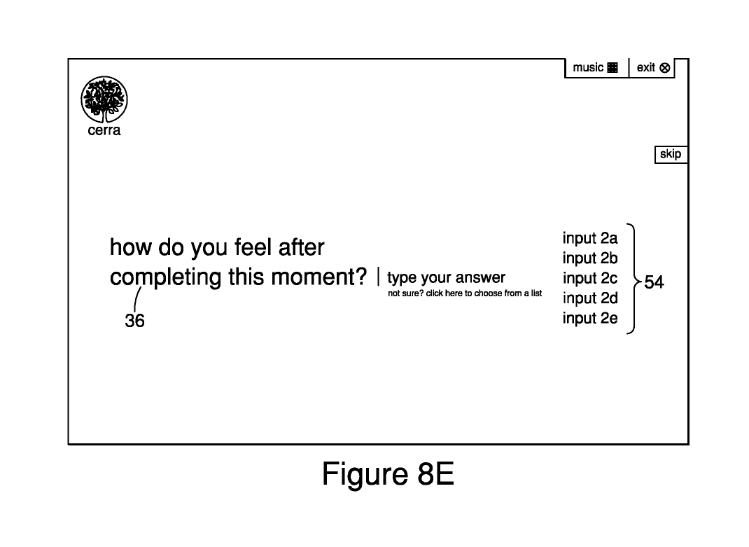

In another guided experience 26 shown in FIGS. 8A-8E, “Joy Breath”, the user is encouraged to use breath and body movement to re-energize. As shown in FIG. 8A, textual and audio prompts encourage the user engage in a physical act 30, here breathing and engaging in various physical movements 56. A series of instructions 28 guide the user through the breathing and physical movements 56, an example of which is shown in FIGS. 8B and 8C. The user is then provided some moments of silence to reflect on the result experienced by the user, as shown in FIG. 8D. Lastly, the personal growth program 518 generates a second information request 36 requesting a second user input relating to the result and feelings experienced by the user after completing the guided experience or moment, as shown in FIG. 8E. If the user is unable to generate his or her own second input 40, she may choose from a predefined list 54 of inputs.

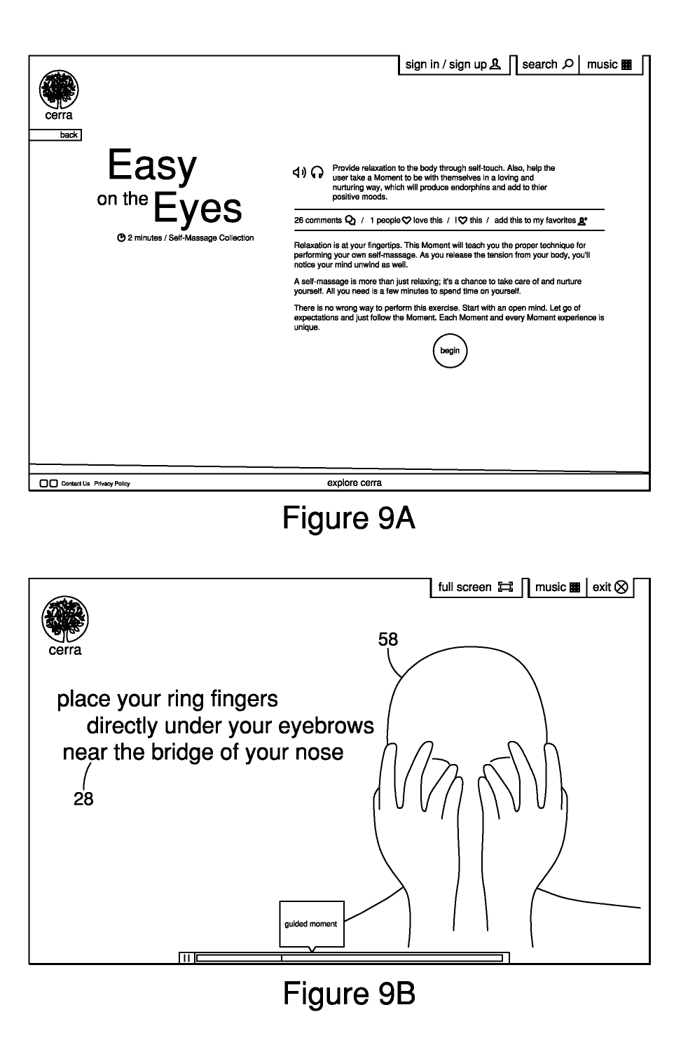

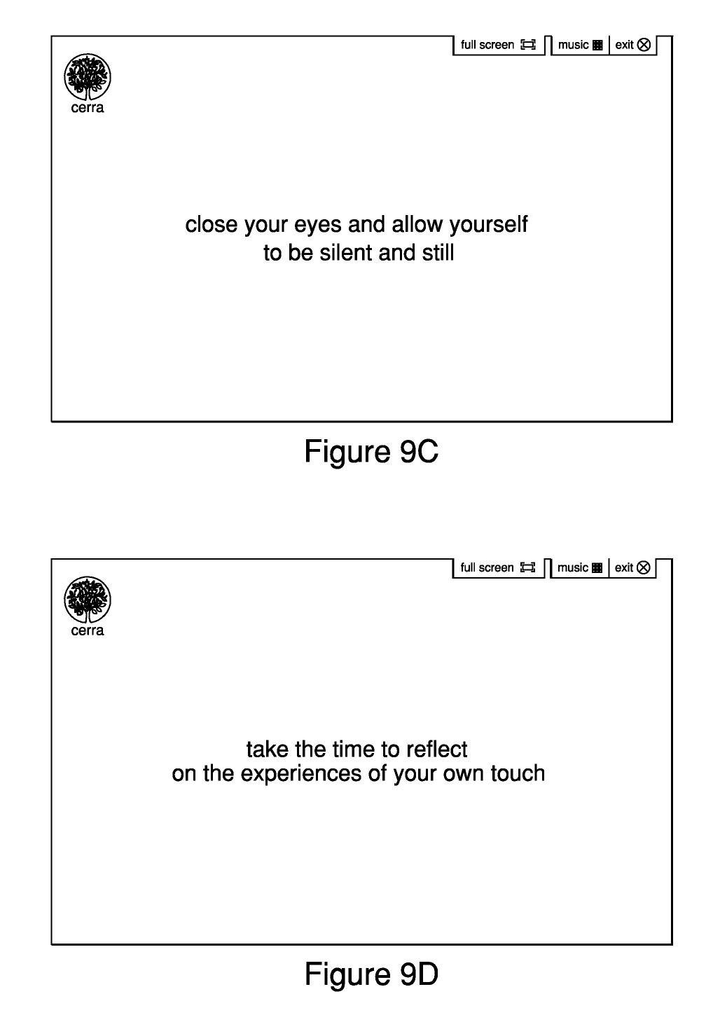

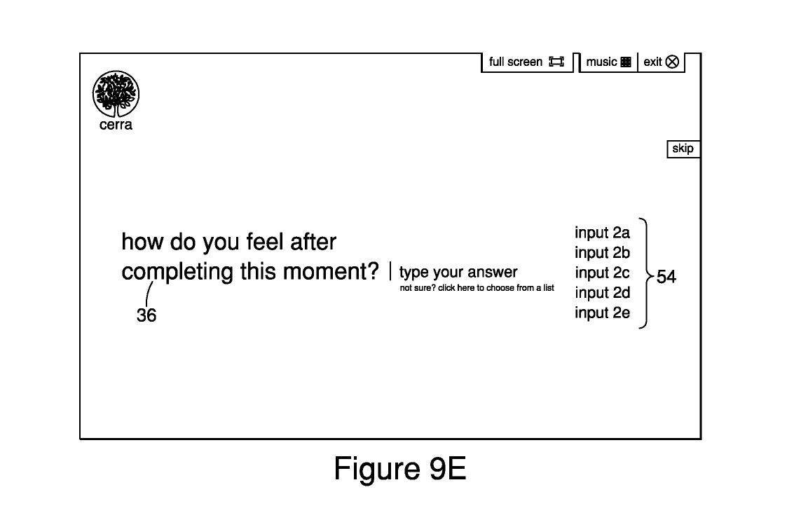

In another guided experience 26, shown in FIGS. 9A-9E, “Easy on the Eyes”, the user is encouraged to use self-massage to promote relaxation. As shown in FIG. 9A, textual and audio prompts encourage the user to engage in a physical act 30, here massaging the area around the eyes. A series of instructions 28 guide the user through the breathing and self-massage 58, an example of which is shown in FIG. 9B. As shown in FIGS. 9C and 9D, the user is then provided some moments of silence to reflect on the result experienced by the user. Lastly, the personal growth program 34 generates a second information request 36 requesting a second user input relating to the result and feelings after completing the guided experience or moment as shown in FIG. 9E. If the user is unable to generate his or her own second input 40, he or she may choose from a predefined list 54 of inputs.

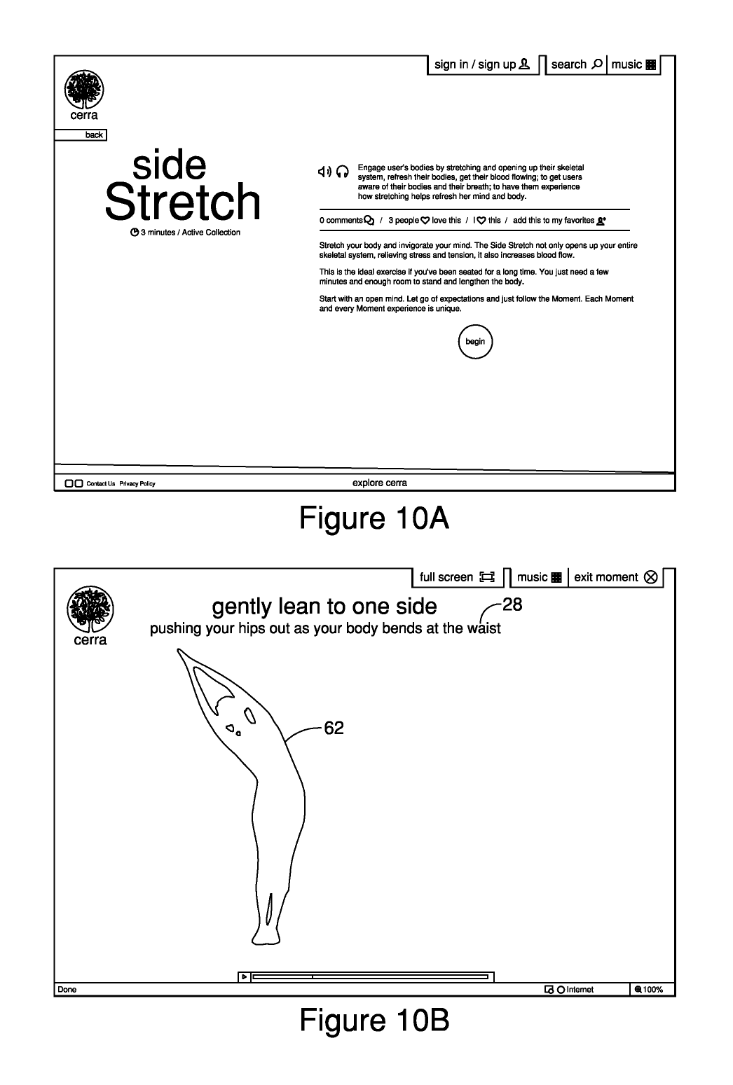

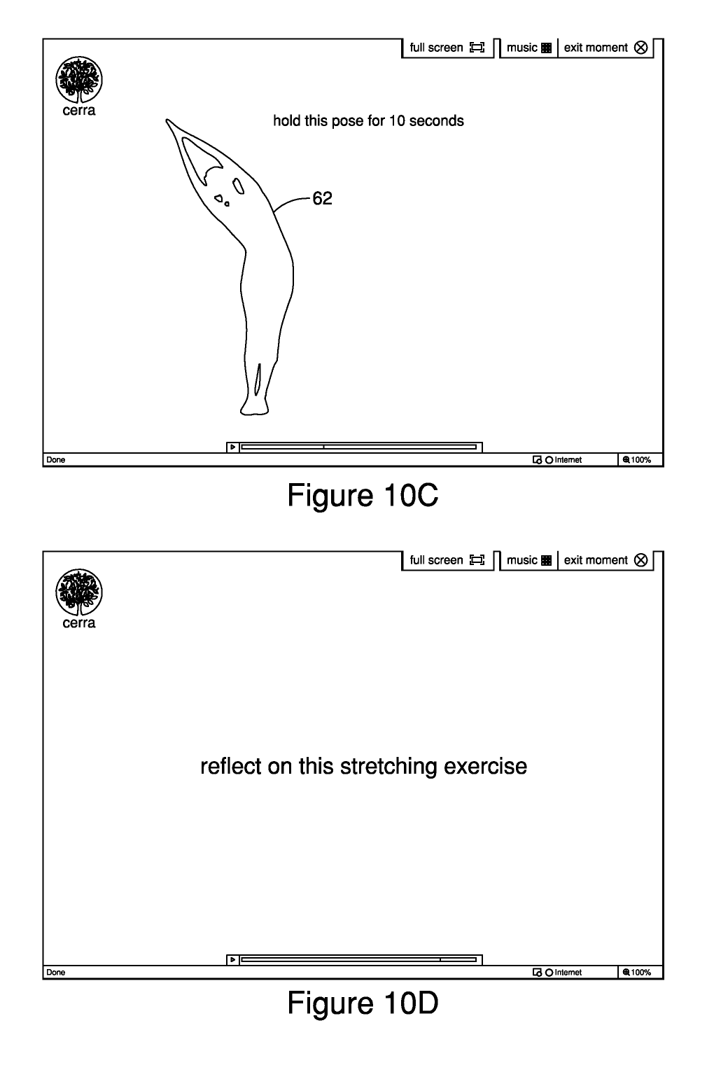

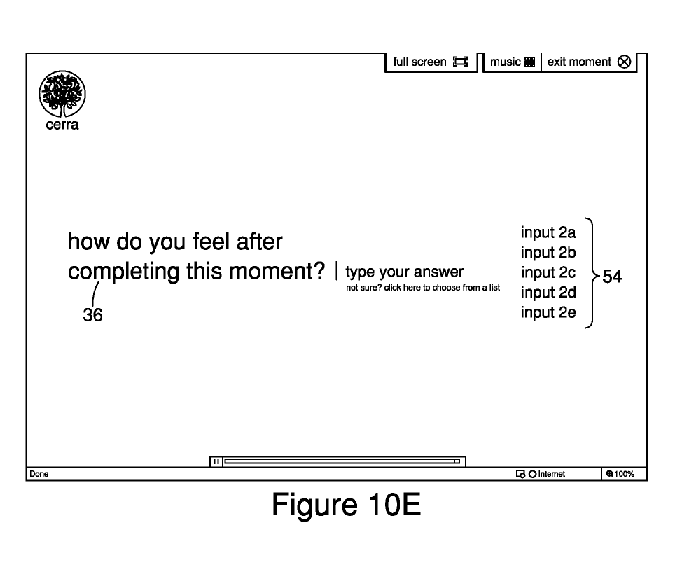

In another guided experience 26 shown in FIGS. 10A-10E, “Side Stretch”, the user is encouraged to use stretching movements in order to get the blood flowing and refresh his or her mind and body. As shown in FIG. 10A, the personal growth program 518 generates textual and audio prompts that encourage the user to engage in a physical act 30, here performing side stretches 62. As in the previous guided experience examples, a series of instructions 28 guide the user through the side stretching 62, an example of which is shown in FIGS. 10B-10C. The user may then be provided some moments of silence to reflect on the result 32 as shown in FIG. 10D. Lastly, the personal growth program 518 generates an information request 36 requesting a second user input relating to the result 32 and feelings after completing the guided experience or moment as shown in FIG. 10E. If the user is unable or unwilling to generate his or her own second input 40, the user may choose from a predefined list 54 of inputs.

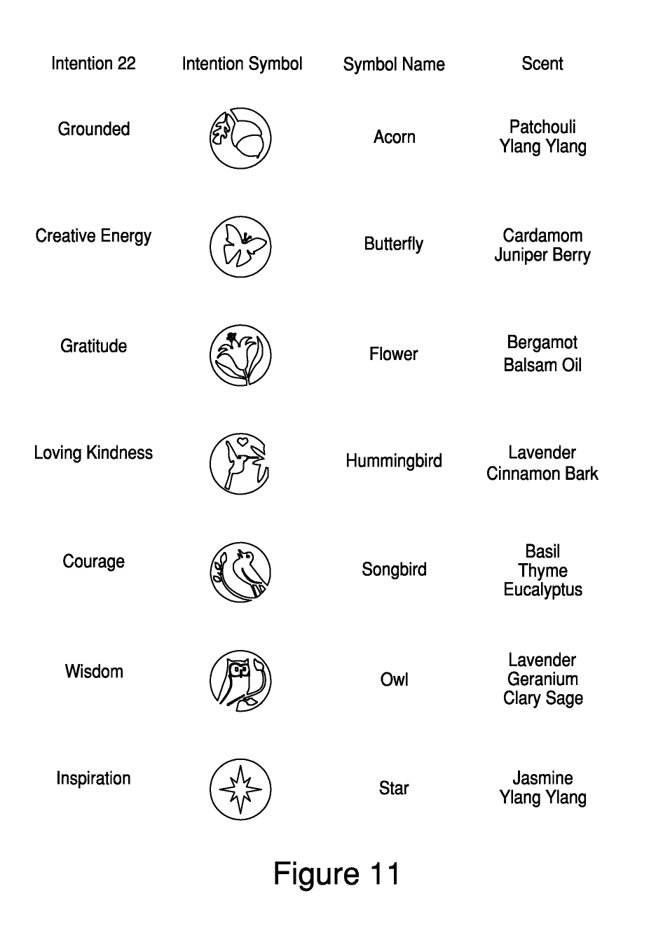

In other embodiments, the guided experience involves physical acts that facilitate attaining a desired mood or state of mind, or that help the user to focus on a particular intention. The intention 22 may be based on a determination to act in a certain way. The intention 22 may be informed by western psychology and inspired by Buddhist teachings and may include, for example: grounded, creative energy, gratitude, loving kindness, courage, wisdom, and inspiration. Each intention 22 may have a symbol and/or a scent associated with it, as shown in FIG. 11. In some embodiments, each intention 22 may have a color associated with the intention 22. The grounded intention may be symbolized by the acorn, the scent associated with the grounded intention may include patchouli and ylang ylang, and the color may be burgundy. The creative energy intention may be symbolized by the butterfly, the scent associated with the creative intention may include cardamom and juniper berry, and the color may be orange. The gratitude intention may be symbolized by the flower, the associated scent may include bergamot and balsam oil, and the color may be green. The loving kindness intention may be symbolized by the hummingbird, the associated scent may include lavender and cinnamon bark, and the color may be pink. The courage intention may be symbolized by the song bird, the associated scent may include basil, thyme and eucalyptus, and the color may be blue. The wisdom intention may be symbolized by the owl, the associated scent may include lavender, geranium and clary sage, and the color may be purple. The inspiration intention may be symbolized by the star, the associated scent may include jasmine and ylang ylang, and the color may be white. Additional intentions 22 may also be used and may include their own symbol, scent and color.

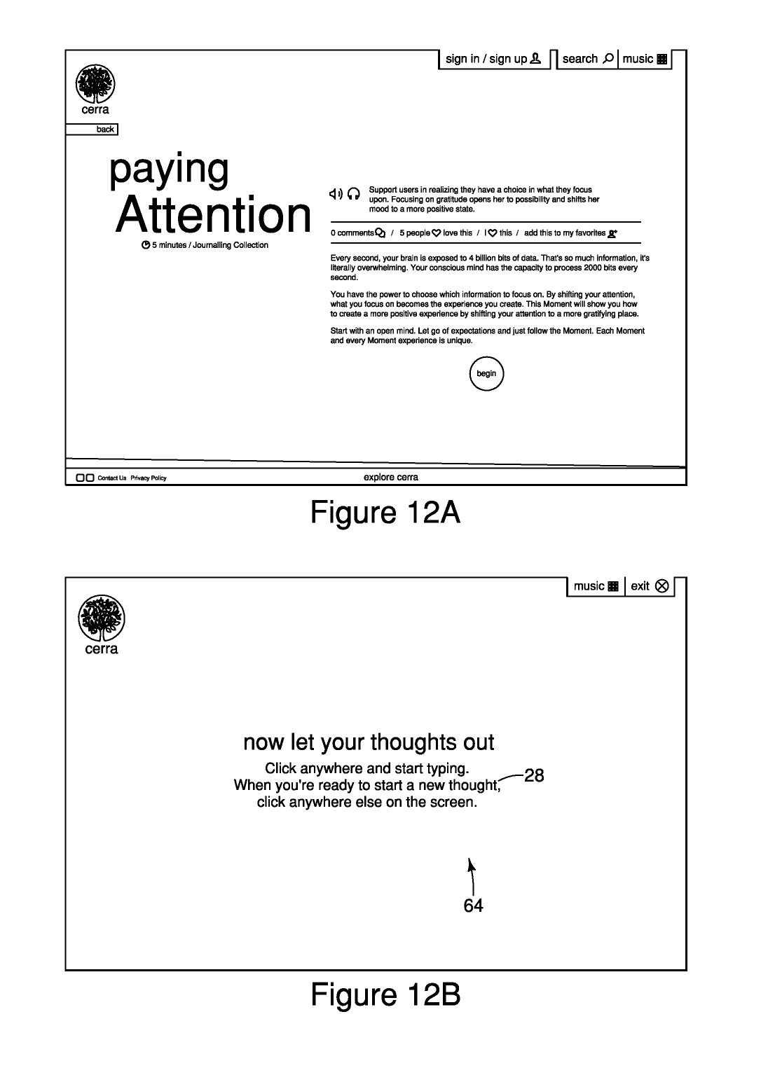

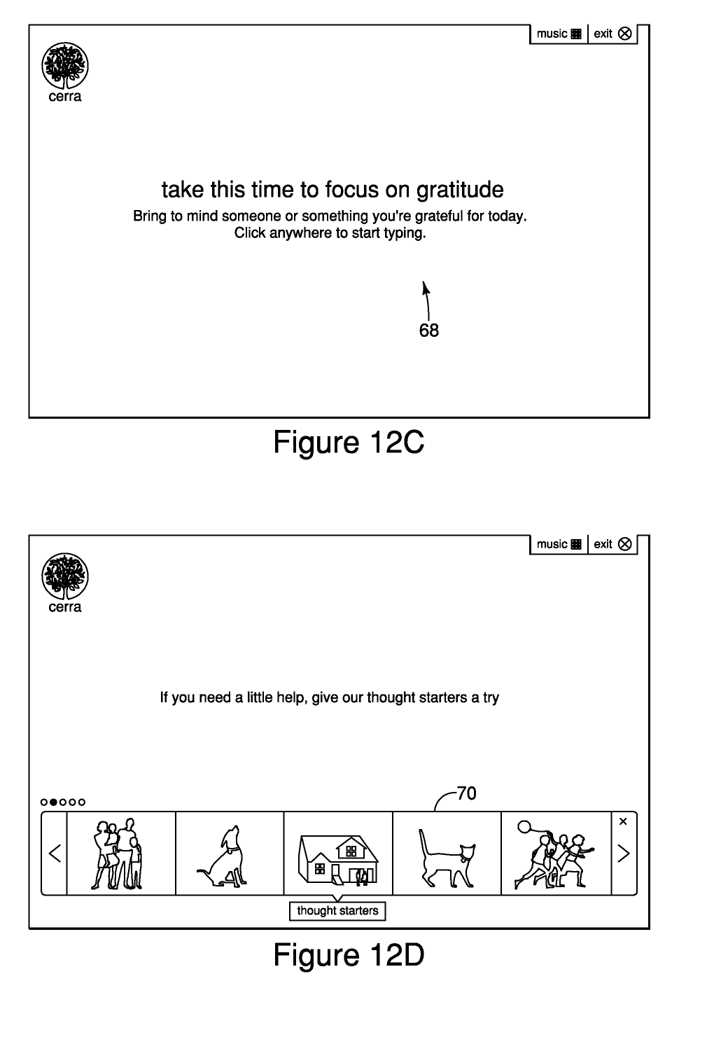

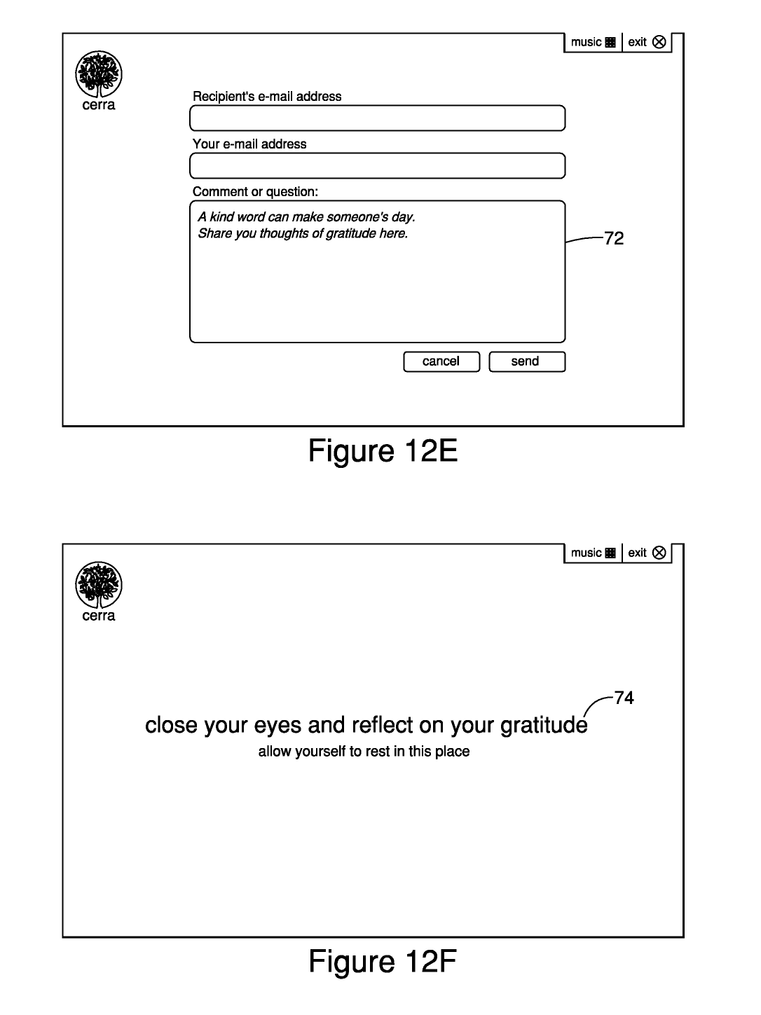

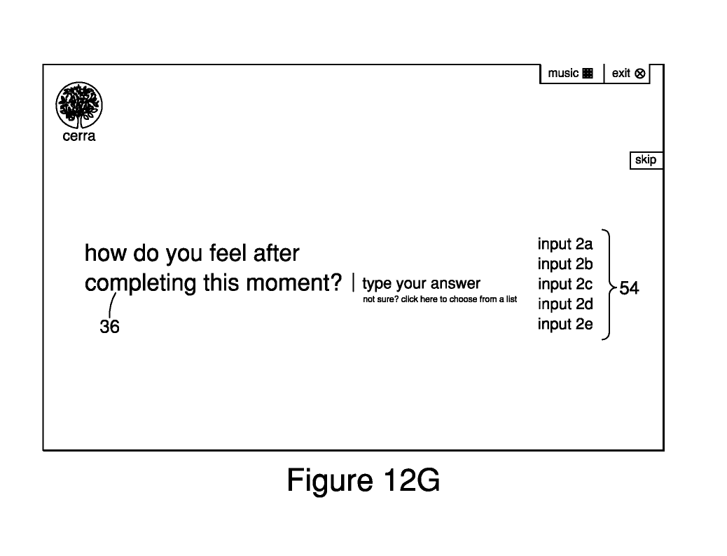

In one embodiment, as shown in FIGS. 12A-12G, the focus of the guided experience “Paying Attention” is the gratitude intention. As shown in FIG. 12A, textual and audio prompts encourages the user engage in a physical act 30, here breathing and journaling 64, writing down her thoughts of the day in on an online platform. A series of instructions 28 guide the user through the breathing and journaling 64, examples of which are shown in FIGS. 12B and 12C. The user is then encouraged via a prompt to focus on gratitude and perform a second physical act 68: type about something or someone she is grateful for, shown in FIG. 12C. If the user is unable to think of anything specific, a menu of thought starters 70 is provided as shown in FIG. 12D. The user provided the opportunity to share a message of gratitude with a friend via email, as shown by the text window 72 in FIG. 12E. A number of textual prompts 74 then encourage the user to reflect on gratitude, as shown in FIG. 12F. Lastly, the personal growth program 518 generates a second information request 36 requesting a second user input relating to the result 32 and feelings after completing the guided experience or moment, shown in FIG. 12G. If the user is unable or unwilling to generate his or her own second input 40, the user may choose from a predefined list 54 of inputs.

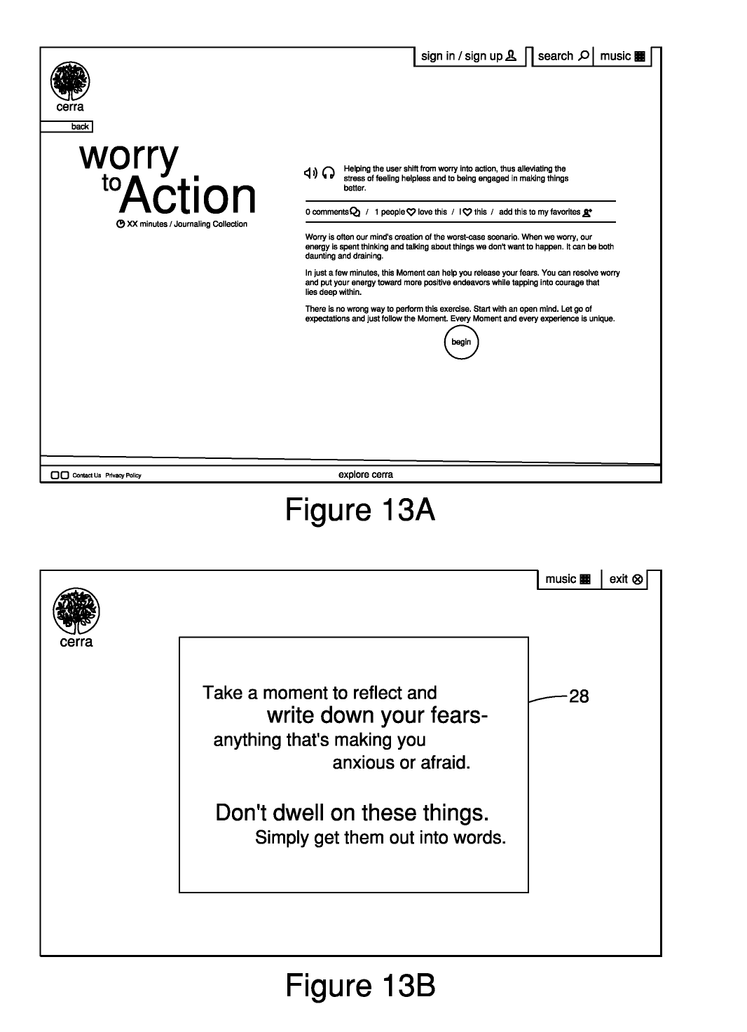

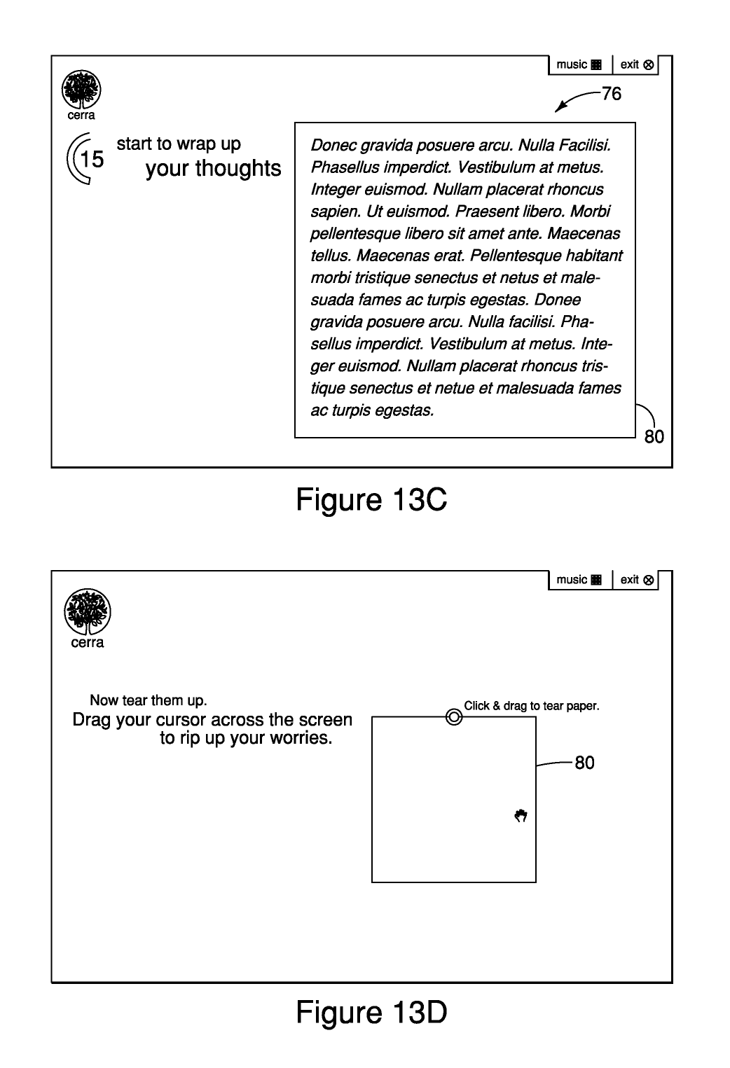

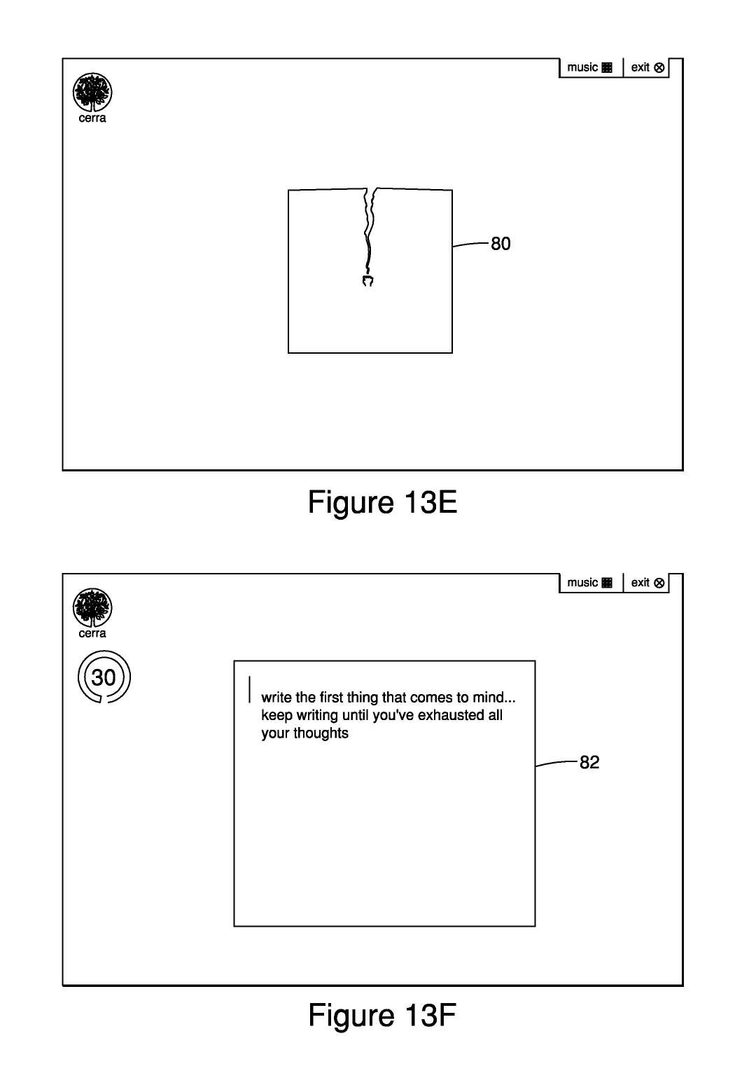

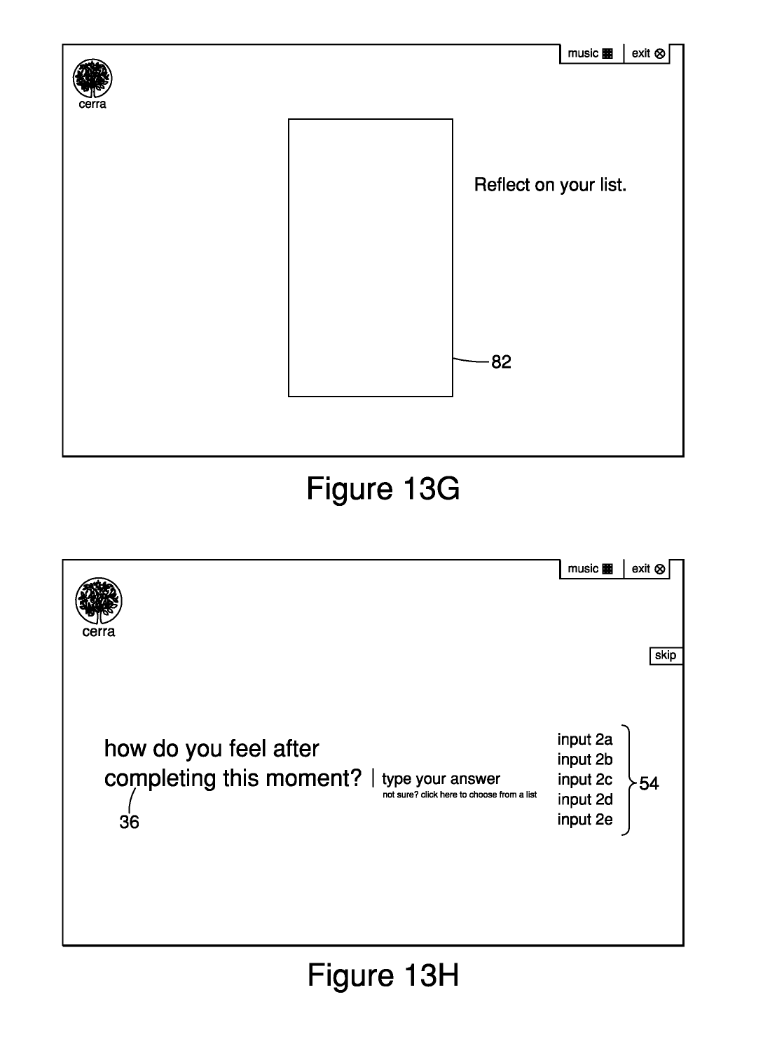

FIGS. 13A-13H show an example of another guided experience 26 focusing on a specific intention, the “Worry to Action” guided experience, which focuses on the intention of courage. Here, the user is encouraged to shift from worry into action. As shown in FIG. 13A, textual and audio prompts encourages the user engage in a physical act 30, here breathing and journaling 76, writing down worries and fears in on an online journal 78. A series of instructions 28 guide the user through the breathing and journaling 76, examples of which are shown in FIGS. 13B and 13C. The user is then encouraged to perform a second act 68, here the virtual act of “tearing up” the online journal entry 80, shown in FIGS. 13C and 13D. This “tearing up” action is another example of interactivity between the system 10 and the user. In particular, the user interacts with the personal growth program 518 (e.g., via mouse movements) to simulate the tearing of paper. The personal growth program 518 monitors for the appropriate mouse movements (e.g., dragging a cursor across a virtual journal entry), and provides feedback in the form of audio, visual, or other feedback to convey tearing of the journal entry. Then, the user is encouraged to create a second journal entry 82, shown in FIG. 13F. The user is then provided with further guidance and is encouraged to reflect on the result 32 as shown in FIG. 13G. Lastly, the personal growth program 518 generates a second information request 36 requesting a second user input relating to the result 32 and feelings after completing the guided experience, as shown in FIG. 13H. If the user is unable or unwilling to generate his or her own second input 40, the user may choose from a predefined list 54.

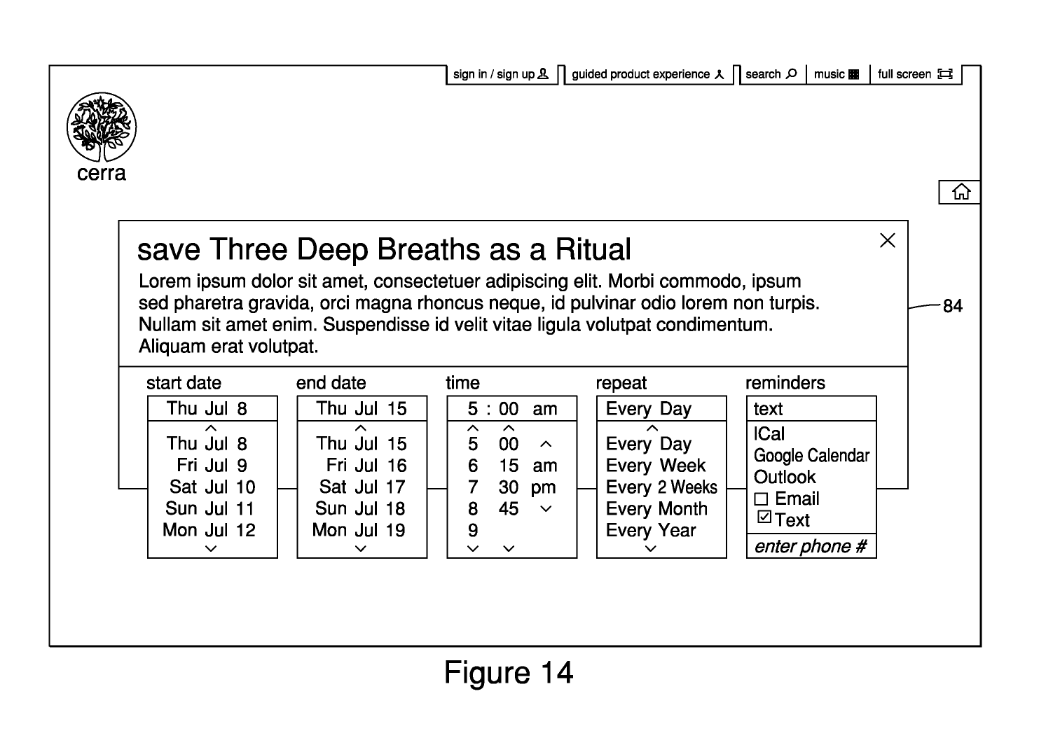

The personal growth system 10 also may be used repeatedly. For example, if a user uses the system to transform his or her mood from stressed to calm in a few minutes, the user may wish to use the system again the next time he or she feels stressed or to incorporate use of the system into his or her schedule on a regular basis. The personal growth system 10 may also include a scheduling program 536 that permits the user to schedule future guided experiences 84, as shown in FIG. 14. Where guided experiences become a regular practice, the practice becomes known as a Ritual.

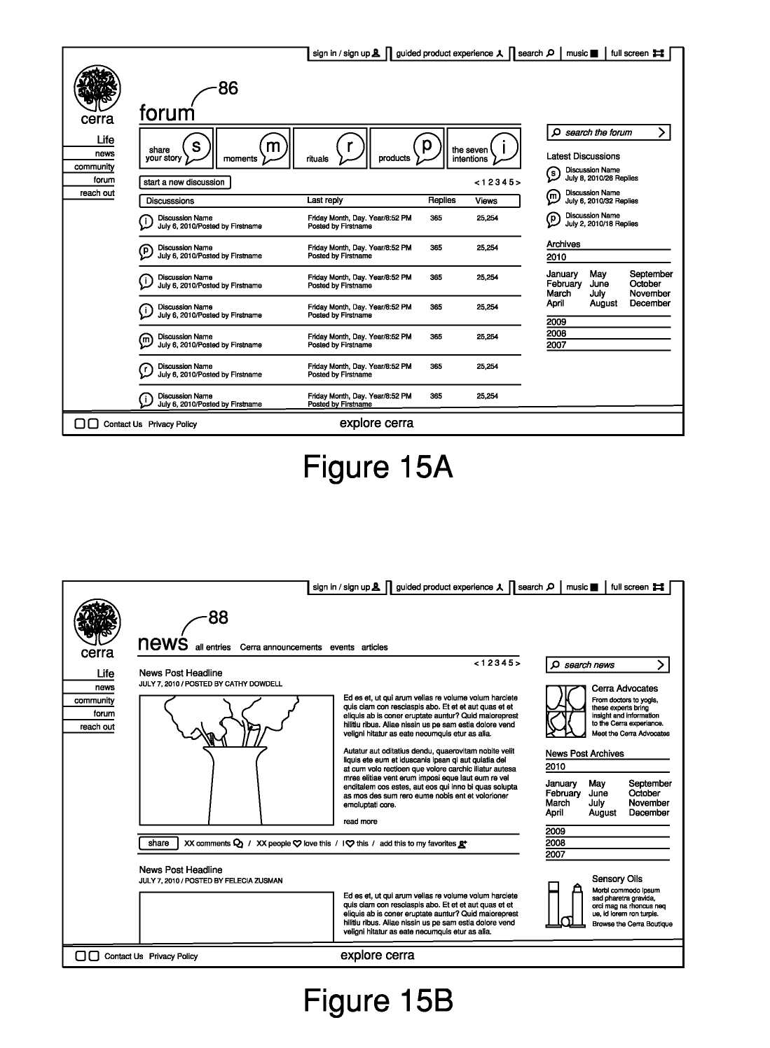

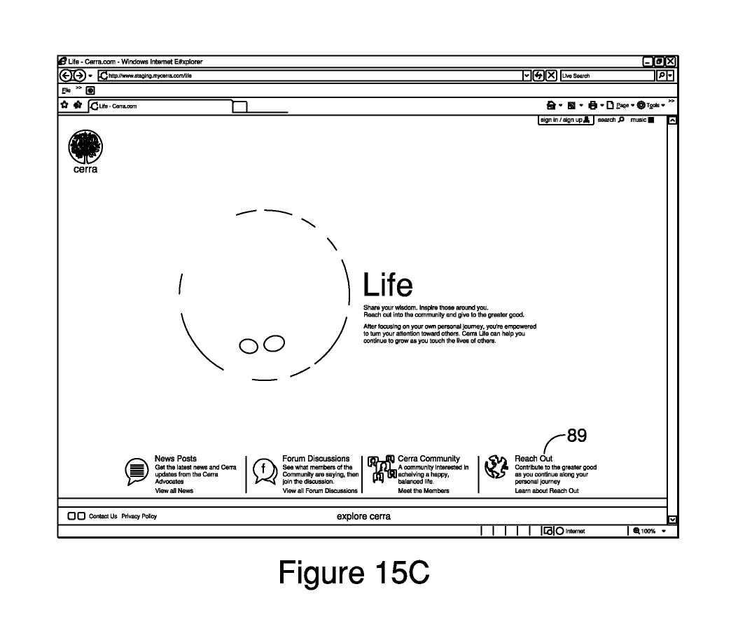

In certain embodiments, the personal growth system 10 includes additional features that allow the user to share his or her experiences with the personal growth system with others and to incorporate guided experiences and rituals more fully into his or her life. This is known as the Life aspect 80 of the personal growth system. The Life aspects include, for example, a forum 86 generated by an online forum program 534, in which users can discuss their experiences with other users. A news section 88 also may be provided where the user can obtain information regarding the personal growth system. A “Reach Out” section 89 may also be provided, which may provide connectivity to external services to present the user with opportunities to contribute to the greater good. In one example, the Reach Out section may include connectivity to any webpage that the system may implement for the user to pursue other goals in furtherance of a guided experience, such as donating to various charities or reaching out in other ways. A screen shot for these life aspects, Forum, News, and Reach Out, are shown in FIGS. 15A,15B, and 15C, respectively. The system also may connect with a mobile device to allow the user of a guided experience to download a particular guided experience to a mobile device.

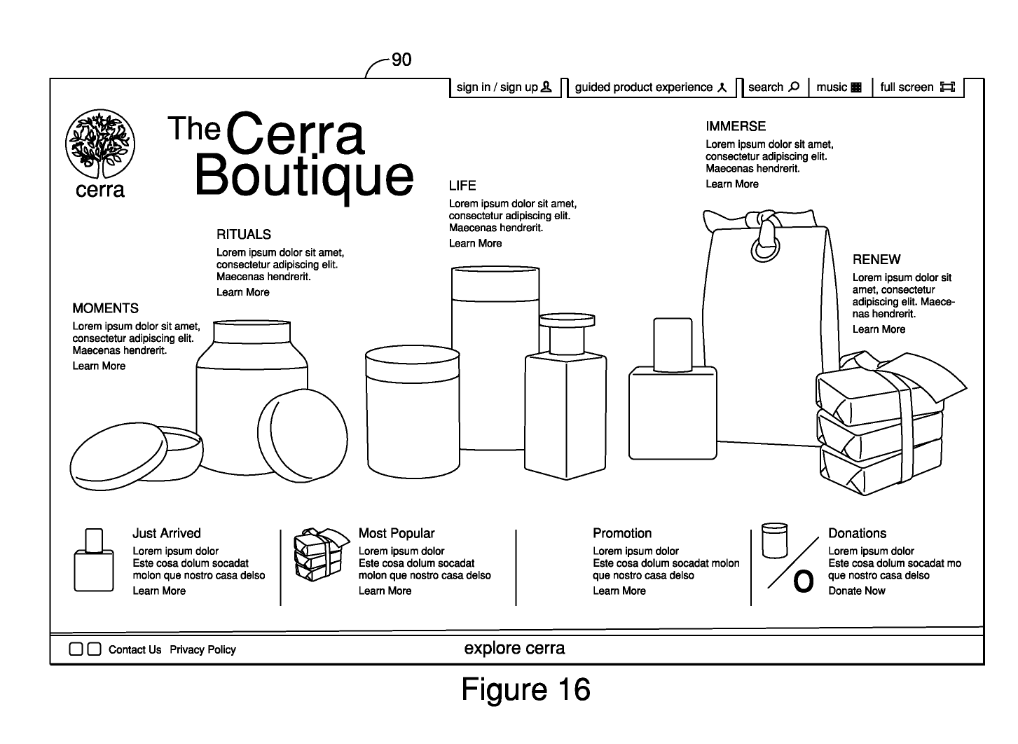

In one embodiment, a personal growth system may include use of a physical product. The physical product 86 may be used alone or in combination with the web-enabled personal growth system 10 to direct the user's thoughts toward awareness and promote personal growth. The physical product may be used to guide the user's thoughts by engaging one or more senses, such as by sight, sound, smell, or touch, for example. Products and services may be defined in the product database 524 and linked to the guided experiences 26. As a result, the personal growth program 518 may recommend products and services that are appropriate for any recommended or selected guided experience 26. The web-enabled personal growth system 10 may include an online boutique 90 which affords the user an opportunity to purchase products, as shown in FIG. 16. Such products may include, for example: an oil, a lotion, a body cleansing product, a bath product, a linen spray, a lip balm, a candle, a package of tea, a note that is dissolvable in water, a set of cards, a journal. The personal growth system 10 may communicate with business support systems (e.g., the billing system 530 and electronic transaction processing system 528) to facilitate and complete purchase orders based on the user purchase input 532.

In one embodiment, a product may be a candle that burns for a particular period of time, such as 30 minutes or 60 minutes. This set time allows the user to engage in a guided experience 26 for a specific period of time, but prevents the user from needing to monitor the clock. In this manner, the candle facilitates awareness and reflection and allows the user to “be in the moment.”

These products may be associated with a particular intention. For example, a creative energy lip balm may incorporate the creative energy scent (cardamom and juniper berry) and flavor notes, while featuring the creative energy color (orange) and symbol (butterfly design) on the label. A product may also encourage the user to engage in a physical gathering with others. A non-limiting example of such a product is a Circle of Friends candle and holder. The design of the Circle of Friends candle holder, which features five persons embracing in a circle, encourages the practice of gathering with friends to promote well-being.

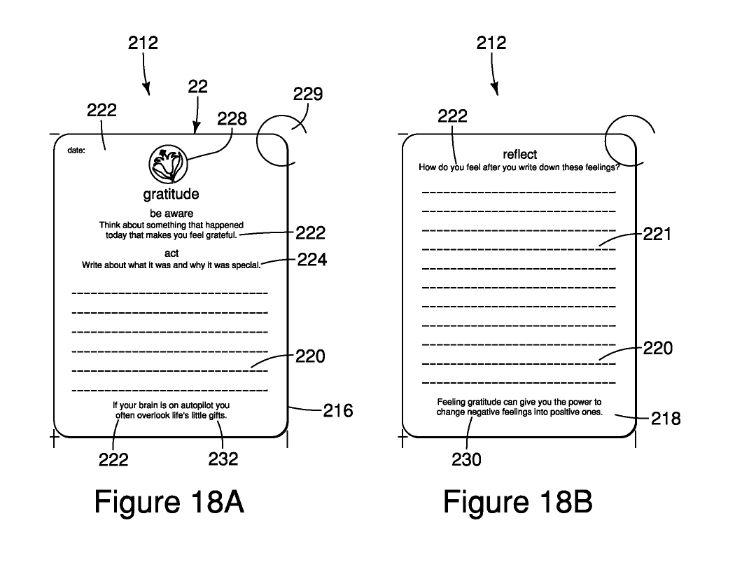

FIGS. 18A and 18B illustrate an embodiment of a personal growth system 200 that includes a journal system 210. The journal system 210 may include one or more cards 212. An exemplary card 212 is illustrated in FIGS. 18A and 18B. As shown, the card 212 may include a first side 216 and a second side 218. One or both of the sides 216, 218 may include a writable portion 220 that is configured to receive one or more entries from a user. The writable portion 220 may include lines 221 or may be open space on the card 212 to receive user entries. One or both sides 216, 218 of the card 212 may also include a written content portion 222. The card 212 may be any size and shape. In some embodiments, the card 212 may be sized to be held in the hand of a user. By way of non-limiting example, the card 212 may be about 3×4 inches, about 3×5 inches or about 4×6 inches. Other sizes for the card 212 may also be used.

As shown in FIGS. 18A and 18B, the card, written content portion 222 may include a prompt 224 to the user to encourage and assist the user in making an entry onto the writable portion 220. The card 212 may include one or more prompts 224 instructing the user to “be aware”, “act” and/or “reflect.” By way of non-limiting example, the “be aware” prompt 224 may instruct the user to think about an event. The “act” prompt 224 may instruct the user to write about the event that the user has become aware of based on the “be aware” prompt 224. The “reflect” prompt 224 may direct the user to reflect on the feelings the act brought about. The user may enter the reflection by writing about the reflection on the writable portion 220 of the card 212.

The journal system 210 may include a plurality of cards 212 wherein the plurality of cards guide the user by including an intention 22. Each plurality of cards 212 may guide the user by including one intention 22. The user may select a specific guided experience 104 based on a desired intention 22. For example, the journal system 210 may include a plurality of cards 212 including grounded intention 22 to guide the user. Another plurality of cards 212 may be include the gratitude intention 22 and other plurality of cards 212 may include one each of the other intentions 22 shown in FIG. 11. FIGS. 18A and 18B are non-limiting examples and illustrate the card 212 including the gratitude intention 22. As shown in FIG. 18A, a symbol 228 is included on the card 212 and illustrates the gratitude symbol 228. The word “gratitude” may also be included on the card 212 as part of the written content portion 222. A message 230 relating to the specific intention 22 may also be included on each card 212. Each of the plurality of cards 212 including the specific intention 22 may be provided together in a packaging. The written content portion 222 may also include a quotation or inspirational message 232. Each card 212 may include a different quotation or inspirational message 232. The plurality of cards 212 may also include written content portion 222 for the date and a writable portion 222 for the user to enter the date upon which the entry is made.

In general, the logic (e.g., programs) for the processing described above for the system 10 may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for example, instructions for execution by a processor, controller, or other processing device. The medium may be implemented as any device or tangible component that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions that perform the processing described above, or in software in an application programming interface (API) or in a Dynamic Link Library (DLL), functions available in a shared memory or defined as local or remote procedure calls, or as a combination of hardware and software.

The system 10 may include additional or different logic and may be implemented in many different ways. A processor may be implemented as a controller, microprocessor, digital signal processor, microcontroller, application specific integrated circuit (ASIC), discrete logic, or a combination of other types of circuits or logic. Similarly, memories may be Dynamic Random Access Memory (DRAM), Static Random Access Memory (SRAM), Flash, or other types of memory. Parameters (e.g., user data, guided experience options, menu options) and other data structures may be separately stored and managed, may be incorporated into a single memory or database, or may be logically and physically organized in many different ways. Programs and instructions may be parts of a single program, separate programs, implemented in libraries such as Dynamic Link Libraries (DLLs), or distributed across several memories, processors, cards, and systems.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A web-enabled personal growth system comprising:
a communication interface operable to communicate with an endpoint user interface comprising a display area;
a personal growth program operable to generate, for a user in the display area, a first information request for the user and to obtain first user input relating to the user's current state of being;
a recommendation database comprising a guided experience group comprising:
first and second guided experiences, each including at least one instruction that leads the user through that guided experience, where the instruction specifies an act intended to generate a result; and
a transition between the first and second guided experiences, the transition comprising a criteria upon which the transition is made from the first guided experience to the second guided experience;
where the personal growth program is further operable to generate, for the user in the display area, a second information request and to obtain second user input relating to the result; and
determine whether to make the transition based on the second user input;
an account database for storing growth interaction history for the user, including the first user input relating to the user's current state of being, the selected guided experience, and the second user input relating to the result of the selected guided experience.

2. The system of claim 1, where the at least one instruction encourages the user to be aware of oneself, the present moment, or the user's surroundings.

3. The system of claim 1, where the personal growth program selects from among the guided experiences based on the first user input relating to the user's current state of being.

4. The system of claim 1, where the selected guided experience is chosen by the user from a list of guided experiences generated by the personal growth program.

5. The system of claim 1, where the personal growth program determines the guided experience using the growth interaction history.

6. The system of claim 1, where the guided experience comprises use of a product comprising an oil, a lotion, a body cleansing product, a bath product, a linen spray, a lip balm, a candle, a package of tea, a note that is dissolvable in water, a set of cards, a journal, or any combination thereof.

7. The system of claim 6, where the product corresponds to an intention specified in the first user input.

8. The system of claim 1, further comprising a product purchase program operable to process a purchase request for any combination of products and services offered to the user in connection with the selected guided experience.

9. The system of claim 1, where the act comprises any combination of:
taking deep breaths, closing eyes, meditating, smelling a scent, viewing an image, performing body movements, listening to music, writing thoughts or feelings on a fixed medium, typing thoughts or feelings on a keyboard, or speaking thoughts or feelings aloud.

10. The system of claim 1, where the personal growth program is further operable to generate and display in the display area a prompt that encourages the user to create a journal entry.

11. The system of claim 1, where the personal growth program is further operable to generate and display in the display area a prompt that notifies the user of an option to download the guided experience to a mobile device.

12. A method of promoting personal growth, the method comprising:
storing in a memory first user input obtained with a personal growth program that prompts a user for first user input specifying a current state of being for the user;
obtaining, from a recommendation database, a guided experience for the user based on the first user input, where the guided experience comprises an instruction for performing an act intended to generate a result for the user;
monitoring the performance of the act with the personal growth program;
providing feedback, with the personal growth program, to the user to regarding the performance of the act;
communicating the instruction, through a communication interface, to an endpoint associated with the user;
communicating, through the communication interface to the endpoint, a request to the user to reflect upon the result and the performance of the act;
using the personal growth program to obtain second user input comprising either or both of: a rating of the guided experience, and information relating to whether the result was obtained for the user; and
storing the second user input in an interaction history for the user in an account database.

13. The method of claim 12, where the first user input specifies a desired intention.

14. The method of claim 12, where the desired intention is selected by the user from a predetermined set of intentions generated by the personal growth program.

15. The method of claim 14, where the predetermined set of intentions comprises and one or more of: grounded, creative energy, gratitude, loving kindness, courage, wisdom, and inspiration.

16. The method of claim 12, where the first user input specifies any one or more of the user's: mood, thoughts, or feelings.

17. The method of claim 12, where the act specified in the guided experience in the recommendation database comprises performance of any combination of: taking deep breaths, closing eyes, meditating, smelling a scent, viewing an image, performing body movements, listening to music, writing thoughts or feelings on a fixed medium, typing thoughts or feelings on a keyboard, or speaking thoughts or feelings aloud.

18. The method of claim 12, further comprising:
communicating, through the communication interface to the endpoint, a recommendation to write in a physical or electronic journal.

19. The method of claim 12, further comprising:
communicating, through the communication interface to the endpoint, a recommendation for the user to engage in the guided experience multiple times by incorporating the guided experience into the person's schedule.

20. The method of claim 12, further comprising:
communicating, through the communication interface to the endpoint, a recommendation for the user to share with others any combination of thoughts, feelings, or emotions relating to the guided experience.

21. The method of claim 12, further comprising:
communicating, through the communication interface to the endpoint, a recommendation for a product, service, or both for the user to purchase in support of the guided experience.

22. The method of claim 21, further comprising:
accepting a purchase request from the user for the product, service, or both; and
processing the purchase request for the user.

23. The system of claim 1, where the act comprises entering information about the user into an online journal to create a virtual journal entry and then interacting with the system to simulate tearing-up the virtual journal entry.

24. The method of claim 12, where the act comprises entering information about the user into an online journal to create a virtual journal entry and then interacting with the personal growth program to simulate tearing-up the virtual journal entry.
